(19) United States
(12) Patent Application Publication
(10) Pub. No.: US 2026/0368350 A1
(43) Pub. Date: Nov. 19, 2026

(54) SPATIAL CONTENT AUTHORIZATION FOR AUGMENTED REALITY RENDERING

(71) Applicant: Metaverse Rights, Inc., Los Angeles, CA (US)

(72) Inventors: Guido Cugi, Cupertino, CA (US); Neil Mandt, Los Angeles, CA (US)

(21) Appl. No.: 19/679,046

(22) Filed: May 15, 2026

Related U.S. Application Data
(60) Provisional application No. 63/806,663, filed on May 15, 2025.

(51) Int. Cl. G06F 21/62; G06F 21/60; G06T 19/00; H04L 9/32

(52) U.S. Cl. CPC G06F 21/6227; G06F 21/602; G06T 19/006; H04L 9/3234

(57) ABSTRACT

A spatial content authorization system receives a rendering authorization request for presenting a digital content item in association with a physical asset or spatial region in an augmented reality environment. The system retrieves a machine-readable presentation policy associated with the physical asset or spatial region and extracts request parameters from the rendering authorization request, including content classification, spatial context, and presentation format parameters. The system compares the request parameters with spatial presentation constraints and content presentation constraints of the machine-readable presentation policy to determine whether the digital content item is permitted to be presented in association with the physical asset or spatial region. Based on the comparison, the system generates a rendering authorization output and transmits the rendering authorization output to an augmented reality rendering system. In some embodiments, an augmented reality user device applies a presentation control operation to render, suppress, relocate, or modify the digital content item.

### CROSS-REFERENCE TO RELATED APPLICATIONS

This application claims priority to U.S. Provisional Patent Application No. 63/806,663, filed May 15, 2025, and titled “Semantic Rights Enforcement For Extended Reality,” the entire contents of which are hereby incorporated by reference herein for all purposes.

### BACKGROUND

### 1. Field

The present disclosure relates generally to computing environments that control presentation of digital content in extended reality (XR) systems, and more particularly to machine-readable policy enforcement for spatially associated augmented reality content.

### 2. Description of the Related Art

In a world increasingly blending the physical with the digital, advertising can find new expression through virtual and augmented reality by overlaying digital content onto real-world environments. For example, users walking down a city street wearing augmented reality (AR) glasses, and instead of static billboards, they see dynamic, personalized ads hovering over buildings, buses, or park benches. These ads may respond to their interests, location, or time of day. These digital layers could be invisible to those without the technology, creating a parallel ad space that coexists with the real world without altering it physically. Virtual reality (VR) takes this a step further by embedding branded content into immersive digital environments, such as placing a virtual soda machine in a VR game or featuring a fashion brand's latest line in a virtual mall, allowing users to interact with products as if they were tangible.

This approach helps advertisers to bypass traditional constraints like zoning laws or printing costs, offering more creative freedom and real-time adaptability. It also allows for more precise targeting, where the same physical location might show different ads to different people depending on their preferences or past behaviors. Whether enhancing a real-world coffee shop with a floating holographic menu sponsored by a coffee brand or embedding subtle brand placements in a VR sports broadcast, the convergence of physical presence and digital augmentation opens up a new frontier for marketing that feels both futuristic and deeply personal.

### SUMMARY

The following is a non-exhaustive listing of some aspects of the present techniques. These and other aspects are described in the following disclosure.

In some aspects, the techniques described herein relate to a computer-implemented method, including: receiving, by one or more processors of a spatial content authorization system, a rendering authorization request for presenting a digital content item in an augmented reality environment, the rendering authorization request identifying the digital content item and a physical asset or spatial region with which the digital content item is proposed to be visually associated; retrieving, by the one or more processors, a machine-readable presentation policy associated with the physical asset or spatial region, the machine-readable presentation policy specifying spatial presentation constraints and content presentation constraints for augmented reality content associated with the physical asset or spatial region; extracting, by the one or more processors and from the rendering authorization request, request parameters including at least a content classification parameter, a spatial-context parameter, and a presentation-format parameter; comparing, by the one or more processors, the request parameters with the machine-readable presentation policy to determine whether the rendering authorization request satisfies the spatial presentation constraints and the content presentation constraints; generating, by the one or more processors and based on the comparing, a rendering authorization output that specifies whether the digital content item is permitted to be presented in association with the physical asset or spatial region; and transmitting, by the one or more processors, the rendering authorization output to an augmented reality rendering system configured to control presentation of the digital content item in the augmented reality environment.

In some aspects, the techniques described herein relate to a computer-implemented method including: obtaining, by one or more processors of an augmented reality user device, sensor data associated with a physical environment of the augmented reality user device; determining, by the one or more processors and based on the sensor data, a physical asset or spatial region within a field of view of the augmented reality user device; accessing, by the one or more processors, authorization data associated with a digital content item proposed for presentation in association with the physical asset or spatial region; determining, by the one or more processors and based on the authorization data, whether presentation of the digital content item in association with the physical asset or spatial region satisfies one or more machine-readable rendering constraints; and controlling, by the one or more processors and based on the determining, presentation of the digital content item by causing the augmented reality user device to apply a presentation control operation to the digital content item relative to the physical asset or spatial region.

Some aspects include a tangible, non-transitory, machine-readable medium storing instructions that when executed by a data processing apparatus cause the data processing apparatus to perform operations including the above-mentioned processes.

Some aspects include a system, including: one or more processors; and a memory storing instructions that when executed by the processors cause the processor to perform the above-mentioned processes.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 illustrates a block diagram of an example spatial content authorization system, in accordance with some embodiments of the present disclosure;

FIG. 2 illustrates a block diagram of an example spatial content authorization computing device of the system of FIG. 1, in accordance with some embodiments of the present disclosure;

FIG. 3 illustrates a block diagram of an example augmented reality user device of the system of FIG. 1, in accordance with some embodiments of the present disclosure;

FIG. 4 illustrates a flowchart of an example method for generating a rendering authorization output for presentation of a digital content item in association with a physical asset or spatial region, in accordance with some embodiments of the present disclosure;

FIG. 5 illustrates a flowchart of an example method for controlling presentation of a digital content item by an augmented reality user device, in accordance with some embodiments of the present disclosure;

FIG. 6 illustrates an example spatial content authorization request flow, in accordance with some embodiments of the present disclosure; and

FIG. 7 illustrates an example computer system that may be implemented by one or more of the devices illustrated in FIGS. 1-6, in accordance with some embodiments of the present disclosure.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the fields of extended reality, artificial intelligence, and digital rights management. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Existing extended reality systems may render digital content in association with physical environments based on device pose, location, visual recognition, application state, or content-placement logic maintained by an application provider. In many implementations, a physical asset, surface, façade, parcel, landmark, or other spatial region may be detected or selected as a target for presentation of digital content without a corresponding machine-readable mechanism for determining whether such presentation is authorized under spatially associated presentation constraints. While such systems may place virtual content in a visually coherent manner, they may lack a technical enforcement layer that associates physical-world regions with machine-readable policies governing whether, when, and how digital content may be rendered relative to those regions.

Conventional content delivery systems also tend to evaluate content eligibility using generic content metadata, application-level settings, or user profile attributes rather than spatial policies bound to physical assets or spatial regions. Such approaches may be insufficient in extended reality environments in which digital content appears to be visually associated with a particular building, surface, location, or other physical-world element. Without a policy representation tied to the spatial region itself, different rendering systems may make inconsistent decisions, may rely on manual configuration, or may require repeated custom integrations to determine whether a digital content item is compatible with a particular physical context.

Additional challenges arise because extended reality rendering contexts may be highly dynamic. A rendering decision may depend not only on a content classification or presentation format, but also on device pose, gaze direction, field of view, viewing angle, viewing distance, ambient conditions, time, interactivity, audio output, occlusion state, and other context signals generated at or near a user device. Existing systems may not provide a reproducible computational mechanism for evaluating these context signals against spatially associated constraints before presentation occurs. As a result, a rendering system may present content that is technically inconsistent with a spatial rule, suppress content unnecessarily, or require a network round trip for each rendering decision, thereby increasing latency and reducing responsiveness in an interactive environment.

Existing systems may further lack a structured mechanism for resolving ambiguity between a digital content item and a spatial presentation policy. For example, a digital content item may include textual, visual, audio, semantic, or metadata attributes that do not exactly match a category or condition specified in a machine-readable policy. A purely rule-based comparison may reject otherwise compatible content or may fail to identify content that should be restricted under a broader semantic condition. Conversely, relying solely on a generative or semantic model may produce non-deterministic or difficult-to-audit authorization behavior. These issues may complicate deployment of content authorization systems in distributed extended reality environments that require consistent, low-latency, and traceable rendering decisions.

Existing extended reality rendering systems may also lack mechanisms for offline or edge enforcement of spatial presentation constraints. A user device may need to determine, within a short rendering interval, whether a digital content item may be presented relative to a detected physical asset or spatial region. If each decision requires communication with a remote authorization server, rendering may be delayed, network connectivity may become a dependency for real-time presentation, and raw location, pose, or gaze signals may be transmitted outside the device. These issues may reduce system performance, increase bandwidth consumption, and expose context data that could otherwise remain local to the user device.

Further challenges arise in maintaining auditability and consistency across distributed rendering systems. A rendering authorization may depend on a particular version of a machine-readable policy, a particular content hash, a particular spatial identifier, and a particular device-context condition. Without cryptographic tokens, policy versioning, signed policy fragments, or audit records, it may be difficult to determine which policy was applied, whether a rendering authorization was modified after issuance, whether a local device enforced the correct constraints, or whether a prior rendering decision can be reproduced for debugging, monitoring, or compliance review.

Embodiments of the present disclosure describe computer-implemented systems and methods for spatial content authorization in extended reality environments. In some embodiments, a spatial content authorization system may receive a rendering authorization request for presenting a digital content item in association with a physical asset or spatial region. The rendering authorization request may identify the digital content item and may identify, directly or indirectly, a building, façade, surface, parcel, landmark, geofence, spatial anchor, or other physical asset or spatial region with which the digital content item is proposed to be visually associated.

The spatial content authorization system may retrieve a machine-readable presentation policy associated with the identified physical asset or spatial region. The machine-readable presentation policy may specify spatial presentation constraints and content presentation constraints for digital content presented in an extended reality environment. In some embodiments, the machine-readable presentation policy may include a geofence identifier, façade identifier, parcel identifier, surface identifier, spatial-anchor identifier, policy version identifier, content classification constraint, presentation-format constraint, viewing-angle constraint, viewing-distance constraint, time-window constraint, interactivity constraint, audio-output constraint, ambient-condition constraint, privacy-condition constraint, impression-count constraint, presentation-duration constraint, or combinations thereof.

In some embodiments, the rendering authorization request may include request parameters associated with a proposed presentation of the digital content item. The request parameters may include a content classification parameter, spatial-context parameter, presentation-format parameter, content hash, device-location parameter, pose parameter, gaze parameter, field of view parameter, viewing-distance parameter, viewing-angle parameter, ambient-condition parameter, interactivity parameter, audio-output parameter, requested presentation duration, requested presentation count, or other context data suitable for evaluating whether the proposed presentation satisfies the machine-readable presentation policy. The request parameters may be received from an application computing device, rendering platform, content source computing device, augmented reality user device, or another computing system coupled to the spatial content authorization system.

The spatial content authorization system may compare the request parameters with the machine-readable presentation policy to determine whether the rendering authorization request satisfies the spatial presentation constraints and the content presentation constraints. In some embodiments, the comparison may include deterministic evaluation of policy fields, such as determining whether a requested spatial region falls within an authorized geofence, whether a requested presentation format is permitted, whether a requested presentation time falls within an authorized time window, whether a requested viewing-angle condition satisfies a viewing-angle threshold, or whether a requested interactivity or audio-output setting satisfies a policy condition.

In some embodiments, when deterministic comparison indicates that the rendering authorization request satisfies the machine-readable presentation policy, the spatial content authorization system may generate a rendering authorization output indicating that the digital content item is permitted to be presented in association with the physical asset or spatial region. When deterministic comparison indicates that one or more constraints are not satisfied, the spatial content authorization system may generate a denial output or may generate a modified rendering authorization output specifying one or more modified presentation parameters under which the digital content item may be presented. The modified presentation parameters may include a modified spatial region, modified presentation format, modified presentation duration, modified viewing-angle condition, modified viewing-distance condition, modified interactivity condition, modified audio-output condition, or other constraint-adjusted presentation condition.

In some embodiments, the spatial content authorization system may perform semantic evaluation of the digital content item relative to the machine-readable presentation policy. The system may generate a semantic representation of the digital content item, metadata associated with the digital content item, textual content associated with the digital content item, visual content associated with the digital content item, audio content associated with the digital content item, or combinations thereof. The system may compare the semantic representation with a semantic representation of at least a portion of the machine-readable presentation policy to determine semantic compatibility between the digital content item and the machine-readable presentation policy.

In some embodiments, semantic compatibility may be determined using an embedding model, language model, multimodal model, classifier, knowledge graph, rules engine, vector similarity process, or combinations thereof. For example, the spatial content authorization system may compute a similarity score between an embedding associated with the digital content item and an embedding associated with one or more policy constraints. The system may determine that a policy condition is satisfied when the similarity score satisfies a threshold and may determine that the policy condition is not satisfied when the similarity score fails to satisfy the threshold. In some embodiments, semantic evaluation may be invoked only when deterministic evaluation is inconclusive, while in other embodiments deterministic and semantic evaluation may be performed in parallel or as part of a hybrid authorization pipeline.

In some embodiments, the spatial content authorization system may include a constraint solving or policy adjustment process configured to identify one or more modified presentation parameters that would cause a rendering authorization request to satisfy a machine-readable presentation policy. For example, the system may determine that a digital content item is not permitted using a first presentation format but is permitted using a second presentation format, that presentation is not permitted at a first viewing distance but is permitted at a second viewing distance, or that presentation is not permitted with an interactive function enabled but is permitted when the interactive function is disabled. The system may generate a modified rendering authorization output identifying the modified presentation parameters and may transmit the modified rendering authorization output to an augmented reality rendering system.

In some embodiments, the spatial content authorization system may generate a cryptographically signed rendering token. The cryptographically signed rendering token may encode at least a portion of the rendering authorization output and one or more rendering constraints applicable to presentation of the digital content item. In some embodiments, the cryptographically signed rendering token may include an identifier of the digital content item, an identifier of the physical asset or spatial region, a version identifier of the machine-readable presentation policy, a permitted rendering region, an expiration time, a presentation-format condition, a content hash, a device-context condition, or a signature generated using a private key associated with the spatial content authorization system.

The cryptographically signed rendering token may allow an augmented reality user device, rendering platform, or other rendering system to verify authorization locally without requiring the rendering system to reperform all server-side policy evaluation operations. In some embodiments, the rendering system may validate the cryptographically signed rendering token using a public key associated with the spatial content authorization system. The rendering system may determine whether token conditions are satisfied, including whether the token has expired, whether a content hash matches the digital content item proposed for presentation, whether a policy version identifier remains valid, whether a spatial-region identifier corresponds to a detected physical asset or spatial region, or whether one or more device-context conditions are satisfied.

In some embodiments, an augmented reality user device may perform device-side rendering enforcement. The augmented reality user device may obtain sensor data associated with a physical environment of the augmented reality user device. The sensor data may include location data, inertial measurement data, camera data, depth-sensing data, pose data, gaze data, field of view data, ambient-light data, orientation data, or combinations thereof. Based on the sensor data, the augmented reality user device may determine a physical asset or spatial region within a field of view of the augmented reality user device.

The augmented reality user device may access authorization data associated with a digital content item proposed for presentation in association with the physical asset or spatial region. The authorization data may include a cryptographically signed rendering token, a signed policy fragment, a locally cached policy record, a policy version identifier, a permitted spatial region, rendering constraints, or combinations thereof. The augmented reality user device may determine, based on the authorization data, whether presentation of the digital content item in association with the physical asset or spatial region satisfies one or more machine-readable rendering constraints.

In some embodiments, the augmented reality user device may maintain a local policy cache. The local policy cache may store signed policy fragments associated with physical assets or spatial regions. The augmented reality user device may retrieve a signed policy fragment from the local policy cache based on a geofence, parcel, façade, surface, landmark, building, spatial anchor, or other identifier determined from sensor data. The augmented reality user device may verify a signature of the signed policy fragment before using the signed policy fragment to determine whether presentation of the digital content item satisfies the machine-readable rendering constraints.

In some embodiments, the augmented reality user device may control presentation of the digital content item by applying a presentation control operation to the digital content item relative to the physical asset or spatial region. The presentation control operation may include rendering the digital content item, suppressing the digital content item, relocating the digital content item, modifying a visual characteristic of the digital content item, delaying presentation of the digital content item, substituting different digital content for the digital content item, disabling an interactive function associated with the digital content item, disabling audio output associated with the digital content item, presenting a placeholder in place of the digital content item, or combinations thereof.

In some embodiments, the augmented reality user device may generate a local audit record indicating the presentation control operation applied to the digital content item. The local audit record may identify whether the digital content item was rendered, suppressed, relocated, modified, delayed, substituted, or otherwise controlled. In some embodiments, the local audit record may exclude raw gaze data or raw location data and may include a privacy-preserving proof, aggregate presentation indicator, token identifier, policy version identifier, content hash, timestamp, device-generated signature, or combinations thereof. The local audit record may be stored locally, transmitted to a remote audit service, or selectively transmitted when network connectivity becomes available.

In some embodiments, the spatial content authorization system may store an audit record associated with a rendering authorization output. The audit record may include a hash of the machine-readable presentation policy, a policy version identifier, a request identifier, a content identifier, timestamp, cryptographic signature, distributed-ledger transaction reference, token identifier, or combinations thereof. In some embodiments, the audit record may be stored in a database, object store, append-only log, permissioned ledger, distributed ledger, or other storage system configured to support later verification of the rendering authorization output.

In some embodiments, the spatial content authorization system may anchor a policy identifier, policy hash, rendering authorization output, token identifier, or audit record to a distributed ledger. The distributed ledger may store a tamper-resistant reference to the policy version or authorization result without requiring storage of raw context data or complete policy content on the distributed ledger. In some embodiments, a rendering system may use the distributed-ledger reference to verify that a rendering authorization output corresponds to a valid policy version, that a signed rendering token has not been revoked, or that a policy update has superseded an earlier policy version.

In some embodiments, machine-readable presentation policies may be generated or updated using property data, mapping data, geospatial data, surface-recognition data, rights-holder input, device-observed spatial data, prior authorization results, or combinations thereof. A policy generation process may identify a physical asset or spatial region, determine one or more default spatial presentation constraints or content presentation constraints, assign a policy version identifier, generate a policy hash or signature, and store the resulting policy in a policy data store. Policy updates may be distributed to rendering systems as full policy records, signed policy fragments, incremental updates, or Merkle-tree-based updates that allow a user device to refresh selected portions of a local policy cache without retrieving an entire policy dataset.

In some embodiments, the spatial content authorization system may maintain policy lifecycle information. The policy lifecycle information may include policy identifiers, policy version identifiers, effective time windows, spatial-region identifiers, source data identifiers, update timestamps, signature metadata, revocation indicators, lineage information, or audit metadata. Maintaining policy lifecycle information may allow the system to determine which version of a machine-readable presentation policy was applied to a particular rendering authorization request and may support reproducibility of rendering authorization decisions.

In some embodiments, feedback information may be used to update spatial content authorization operations. Feedback information may include rendering outcomes, suppressed presentation counts, token validation failures, policy mismatch indicators, semantic matching scores, device-side audit records, content hash mismatch indicators, expired-token indicators, user-device performance metrics, latency metrics, or other operational signals. The spatial content authorization system may use feedback information to adjust semantic matching thresholds, update presentation policy fields, modify constraint solving rules, identify stale policy fragments, update policy distribution schedules, or detect anomalous rendering authorization behavior.

The disclosed systems and methods provide several technical improvements to computing systems that control presentation of digital content in extended reality environments. By associating physical assets and spatial regions with machine-readable presentation policies, the disclosed architecture provides a structured computational mechanism for evaluating whether digital content may be rendered relative to particular physical-world contexts. This improves consistency of rendering decisions across distributed rendering systems and reduces reliance on application-specific, manually configured, or non-reproducible placement logic.

The disclosed hybrid evaluation techniques further improve operation of content authorization systems by combining deterministic policy comparison with semantic compatibility evaluation. Deterministic policy comparison supports reproducible enforcement of explicit constraints, while semantic evaluation enables the system to resolve non-exact matches between content attributes and policy conditions. By using semantic representations as inputs to a controlled authorization pipeline rather than treating semantic model outputs as unbounded final decisions, the system improves reliability, auditability, and consistency of rendering authorization operations.

The disclosed token and signed-policy-fragment techniques improve distributed rendering systems by allowing rendering authorization decisions to be verified locally by an augmented reality user device or rendering platform. Local verification reduces the need for repeated network calls during real-time rendering, decreases latency, reduces bandwidth consumption, and enables operation during intermittent connectivity. In addition, local verification allows raw gaze data, raw location data, or other sensitive device-context signals to remain on the user device while still enforcing machine-readable rendering constraints.

The disclosed audit and policy-versioning techniques improve traceability and reproducibility in distributed extended reality environments. By storing policy version identifiers, content hashes, token identifiers, cryptographic signatures, local audit records, or distributed-ledger references, the system can later determine which policy version and which authorization output controlled a rendering decision. Such traceability supports debugging, monitoring, revocation, policy updates, and verification across systems in which rendering devices, authorization servers, content sources, policy stores, and ledger systems may be updated or scaled independently.

In distributed computing environments, the modular separation of policy storage, request processing, deterministic constraint evaluation, semantic compatibility evaluation, token generation, local device verification, presentation control, and audit storage enables independent scaling, updating, and optimization of system components. As a result, embodiments of the present disclosure may improve rendering latency, reduce unnecessary network communication, enhance consistency of spatially constrained rendering decisions, preserve device-context privacy, and provide more reliable and auditable control of digital content presentation in extended reality systems.

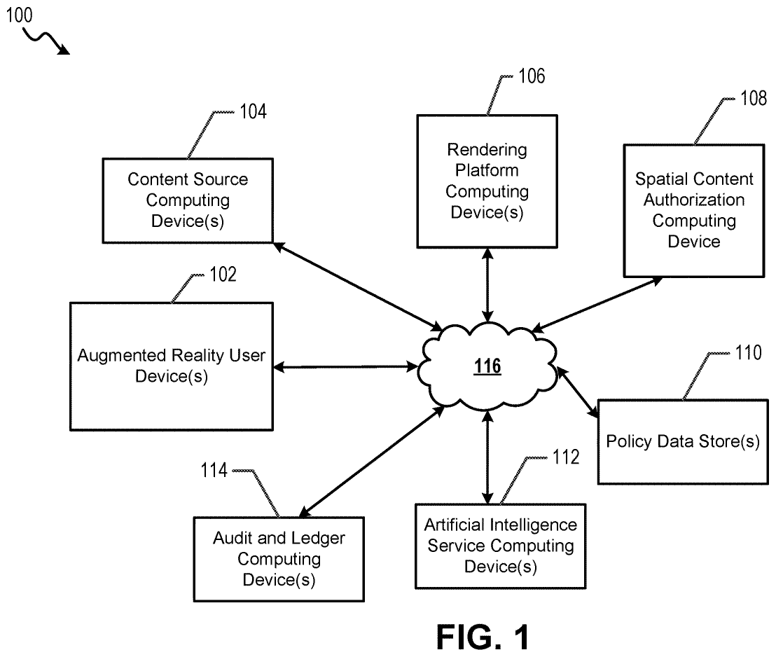

FIG. 1 illustrates an example spatial content authorization system 100 suitable for implementing embodiments of the present disclosure. The spatial content authorization system 100 may include one or more augmented reality user devices 102, one or more content source computing devices 104, one or more rendering platform computing devices 106, a spatial content authorization computing device 108, one or more policy data stores 110, one or more artificial intelligence service computing devices 112, one or more audit and ledger computing devices 114, and a network 116 that enables data communication among these components. The configuration shown in FIG. 1 is merely illustrative; other embodiments may include additional, fewer, or alternative components, and functionality described with respect to a single element may, in some implementations, be distributed across multiple physical or virtual computing resources.

In various embodiments, the spatial content authorization system 100 may include one or more augmented reality user devices 102 configured to present digital content in association with a physical environment. The augmented reality user devices 102 may include head-mounted displays, smart glasses, mobile telephones, tablet computing devices, vehicle-mounted displays, wearable computing devices, projection systems, or other computing devices configured to generate an augmented reality presentation. Each augmented reality user device 102 may include one or more processors and a non-transitory memory storing instructions that, when executed, cause the augmented reality user device 102 to obtain sensor data associated with a physical environment, determine a physical asset or spatial region within a field of view, receive or access authorization data associated with a digital content item, and control presentation of the digital content item relative to the physical asset or spatial region. In some embodiments, the augmented reality user devices 102 may include cameras, depth sensors, inertial measurement units, location sensors, gaze sensors, ambient-light sensors, display systems, audio systems, wireless communication systems, or combinations thereof.

In various embodiments, the spatial content authorization system 100 may include one or more content source computing devices 104 configured to store, provide, or identify digital content items that may be presented in an augmented reality environment. The content source computing devices 104 may represent content repositories, content management systems, application servers, media servers, creative-content systems, content classification services, or other computing systems that maintain digital content items and associated metadata. In some embodiments, a content source computing device 104 may provide a digital content item, a content identifier, a content classification parameter, a content hash, presentation-format metadata, semantic metadata, visual metadata, audio metadata, or other information used by the spatial content authorization computing device 108 or the rendering platform computing devices 106 to evaluate whether the digital content item may be presented relative to a physical asset or spatial region.

In various embodiments, the spatial content authorization system 100 may include one or more rendering platform computing devices 106 configured to coordinate presentation of digital content items through the augmented reality user devices 102. The rendering platform computing devices 106 may represent application servers, extended reality platform services, content-placement services, rendering orchestration services, spatial mapping services, or other computing platforms that communicate with augmented reality user devices 102. In some embodiments, a rendering platform computing device 106 may receive or generate a rendering authorization request identifying a digital content item and a physical asset or spatial region with which the digital content item is proposed to be visually associated. The rendering platform computing device 106 may transmit the rendering authorization request to the spatial content authorization computing device 108 and may receive a rendering authorization output indicating whether the digital content item is permitted to be presented, or indicating one or more machine-readable rendering constraints under which presentation is permitted.

In various embodiments, the spatial content authorization system 100 may include the spatial content authorization computing device 108, which may serve as a computing component responsible for evaluating rendering authorization requests using machine-readable presentation policies. The spatial content authorization computing device 108 may receive rendering authorization requests from the rendering platform computing devices 106, the content source computing devices 104, the augmented reality user devices 102, or other computing systems. In some embodiments, the spatial content authorization computing device 108 may retrieve a machine-readable presentation policy associated with a physical asset or spatial region, extract request parameters from a rendering authorization request, compare the request parameters with spatial presentation constraints and content presentation constraints of the machine-readable presentation policy, and generate a rendering authorization output based on the comparison. The spatial content authorization computing device 108 may be implemented using cloud-hosted services, on-premises computing infrastructure, distributed microservices, virtual machines, containerized services, edge services, or combinations thereof.

In some embodiments, the spatial content authorization computing device 108 may perform deterministic policy evaluation, semantic compatibility evaluation, constraint solving, rendering-token generation, policy-version verification, or audit-record generation. For example, the spatial content authorization computing device 108 may determine whether request parameters satisfy policy constraints associated with a geofence, façade, parcel, surface, spatial anchor, time window, viewing angle, viewing distance, presentation format, interactivity setting, audio-output setting, ambient condition, content classification, privacy condition, or other rendering condition. In some embodiments, when one or more policy constraints are not satisfied, the spatial content authorization computing device 108 may generate a modified rendering authorization output specifying one or more modified presentation parameters under which a digital content item may be presented.

In various embodiments, the spatial content authorization system 100 may include one or more policy data stores 110 configured to store machine-readable presentation policies and related policy metadata. The policy data stores 110 may store policy records associated with physical assets or spatial regions, including policy identifiers, policy version identifiers, geofence identifiers, façade identifiers, parcel identifiers, surface identifiers, spatial-anchor identifiers, permitted presentation formats, content classification constraints, spatial constraints, temporal constraints, device-context constraints, signed policy fragments, policy hashes, revocation indicators, update metadata, or lineage metadata. The policy data stores 110 may implement access control, indexing, versioning, cryptographic signing, metadata management, or policy-distribution functions that support retrieval, traceability, auditability, and distribution of machine-readable presentation policies to other components of the spatial content authorization system 100.

In various embodiments, the spatial content authorization system 100 may include one or more artificial intelligence service computing devices 112 configured to execute one or more artificial intelligence models used by the spatial content authorization computing device 108. The artificial intelligence service computing devices 112 may execute or provide access to one or more embedding models, language models, multimodal classification models, semantic similarity models, content classification models, constraint-evaluation models, or other machine learning models. In some embodiments, an artificial intelligence service computing device 112 may generate a semantic representation of a digital content item, metadata associated with the digital content item, or a portion of a machine-readable presentation policy. The artificial intelligence service computing device 112 may provide model outputs to the spatial content authorization computing device 108 for use in determining semantic compatibility between the digital content item and the machine-readable presentation policy. In other embodiments, some or all functionality described with respect to the artificial intelligence service computing devices 112 may be implemented within the spatial content authorization computing device 108.

In various embodiments, the spatial content authorization system 100 may include one or more audit and ledger computing devices 114 configured to store or verify audit information associated with rendering authorization operations. The audit and ledger computing devices 114 may include audit-log systems, append-only data stores, permissioned ledgers, distributed ledgers, blockchain networks, ledger nodes, smart-contract execution systems, hash-anchoring services, or other verification systems. In some embodiments, the audit and ledger computing devices 114 may store or verify audit records, policy hashes, token identifiers, cryptographic signatures, policy-version references, rendering authorization outputs, signed policy-fragment references, revocation indicators, or distributed-ledger transaction references. The audit and ledger computing devices 114 may enable later verification that a rendering authorization output corresponds to a particular policy version, content identifier, spatial-region identifier, token identifier, or cryptographic signature.

In various embodiments, the spatial content authorization system 100 may include the network 116, which provides communication among the various computing devices and services. The network 116 may comprise any combination of public or private communication infrastructures, including the Internet, intranets, local area networks, wide area networks, cellular networks, short-range wireless networks, enterprise networks, or cloud-service backbones. The network 116 may support wired, wireless, or hybrid connectivity and may employ secure communication protocols such as Transport Layer Security (TLS), virtual private network tunneling, message-level encryption, mutual authentication, signed requests, or other cryptographic communication mechanisms to protect transmitted data.

In operation, the spatial content authorization system 100 may receive a rendering authorization request from a rendering platform computing device 106, a content source computing device 104, an augmented reality user device 102, or another computing system. The rendering authorization request may identify a digital content item and a physical asset or spatial region with which the digital content item is proposed to be visually associated. The spatial content authorization computing device 108 may retrieve, from the policy data stores 110, a machine-readable presentation policy associated with the physical asset or spatial region and may compare request parameters of the rendering authorization request with spatial presentation constraints and content presentation constraints of the machine-readable presentation policy. In some embodiments, the spatial content authorization computing device 108 may use the artificial intelligence service computing devices 112 to determine semantic compatibility between the digital content item and the machine-readable presentation policy. Based on the comparison, the spatial content authorization computing device 108 may generate a rendering authorization output and transmit the rendering authorization output to the rendering platform computing device 106 or the augmented reality user device 102.

In some embodiments, the rendering authorization output may include a cryptographically signed rendering token, a modified rendering authorization output, one or more machine-readable rendering constraints, or an indication that presentation is not permitted. The augmented reality user device 102 may use the rendering authorization output to apply a presentation control operation to the digital content item relative to the physical asset or spatial region. For example, the augmented reality user device 102 may render the digital content item, suppress the digital content item, relocate the digital content item, modify a visual characteristic of the digital content item, delay presentation of the digital content item, substitute different digital content for the digital content item, disable an interactive function or audio output associated with the digital content item, or present a placeholder in place of the digital content item. The spatial content authorization computing device 108, the augmented reality user device 102, or both may store audit information using the audit and ledger computing devices 114. Accordingly, the spatial content authorization system 100 provides a scalable and modular architecture for controlling presentation of digital content relative to physical assets and spatial regions in augmented reality computing environments.

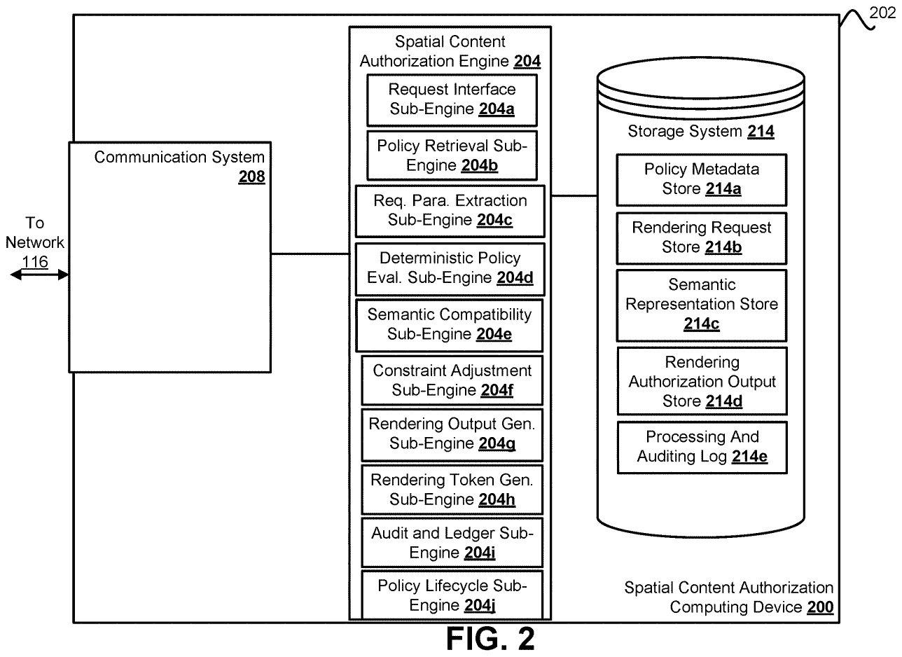

FIG. 2 illustrates an embodiment of a spatial content authorization computing device 200 that may be the spatial content authorization computing device 108 discussed above with reference to FIG. 1. In the illustrated embodiment, the spatial content authorization computing device 200 may include a chassis 202 that houses various components of the device. In various embodiments, the spatial content authorization computing device 200 may be implemented using one or more computing platforms, such as servers, cloud-based environments, containerized applications, virtual machines, edge computing nodes, distributed microservices, or combinations thereof configured to perform the functionality described herein. In some embodiments, the chassis 202 may house a processing system and a non-transitory memory system that includes instructions which, when executed by the processing system, cause the spatial content authorization computing device 200 to provide a spatial content authorization engine 204.

The spatial content authorization engine 204 may be configured to coordinate receipt of rendering authorization requests, retrieval of machine-readable presentation policies, extraction of request parameters, evaluation of spatial presentation constraints and content presentation constraints, generation of rendering authorization outputs, generation of cryptographically signed rendering tokens, and storage or anchoring of audit information. In various embodiments, the spatial content authorization engine 204 may include several sub-engines. A request interface sub-engine 204a may be configured to receive rendering authorization requests from one or more rendering platform computing devices 106, content source computing devices 104, augmented reality user devices 102, or other computing systems. In various embodiments, the request interface sub-engine 204a may receive requests through application programming interfaces, service endpoints, message queues, streaming interfaces, software development kits, or other communication mechanisms. The request interface sub-engine 204a may parse received requests, validate request formats, associate requests with request identifiers or session identifiers, and route validated requests to other sub-engines of the spatial content authorization engine 204.

A policy retrieval sub-engine 204b may be configured to retrieve machine-readable presentation policies associated with physical assets or spatial regions identified in rendering authorization requests. In various embodiments, the policy retrieval sub-engine 204b may query one or more policy data stores 110 using a geofence identifier, façade identifier, parcel identifier, surface identifier, spatial-anchor identifier, landmark identifier, building identifier, coordinate range, device-context parameter, or other spatial identifier. In some embodiments, the policy retrieval sub-engine 204b may retrieve a policy record, policy version identifier, signed policy fragment, policy hash, revocation status, effective time window, or other policy metadata used to evaluate a proposed presentation of a digital content item relative to a physical asset or spatial region.

A request parameter extraction sub-engine 204c may be configured to extract request parameters from a rendering authorization request. In various embodiments, the request parameter extraction sub-engine 204c may extract a content identifier, content classification parameter, content hash, presentation-format parameter, spatial-context parameter, device-location parameter, pose parameter, gaze parameter, field of view parameter, viewing-distance parameter, viewing-angle parameter, ambient-condition parameter, interactivity parameter, audio-output parameter, requested presentation duration, requested presentation count, or other parameter usable to evaluate the rendering authorization request. In some embodiments, the request parameter extraction sub-engine 204c may normalize, validate, encode, or transform request parameters into a machine-consumable representation suitable for comparison with a machine-readable presentation policy.

A deterministic policy evaluation sub-engine 204d may be configured to compare request parameters with deterministic constraints of a machine-readable presentation policy. In various embodiments, the deterministic policy evaluation sub-engine 204d may determine whether a proposed presentation satisfies spatial presentation constraints and content presentation constraints, including constraints associated with a permitted spatial region, viewing angle, viewing distance, field of view, time window, presentation format, content classification, interactivity setting, audio-output setting, ambient condition, device-context condition, privacy condition, presentation duration, or presentation count. In some embodiments, the deterministic policy evaluation sub-engine 204d may generate one or more constraint satisfaction indicators identifying which policy constraints are satisfied, not satisfied, or inconclusive.

A semantic compatibility sub-engine 204e may be configured to determine semantic compatibility between a digital content item and at least a portion of a machine-readable presentation policy. In various embodiments, the semantic compatibility sub-engine 204e may generate or obtain semantic representations of a digital content item, metadata associated with the digital content item, textual content associated with the digital content item, visual content associated with the digital content item, audio content associated with the digital content item, or combinations thereof. The semantic compatibility sub-engine 204e may compare those semantic representations with semantic representations of policy fields or policy constraints. In some embodiments, the semantic compatibility sub-engine 204e may access one or more artificial intelligence service computing devices 112 to obtain embeddings, classification outputs, similarity scores, multimodal content classifications, or other model outputs. In some embodiments, semantic compatibility may be determined using vector similarity, nearest-neighbor search, classification models, language models, multimodal models, knowledge graph traversal, rules engines, or combinations thereof.

A constraint adjustment sub-engine 204f may be configured to identify one or more modified presentation parameters when a rendering authorization request does not satisfy one or more constraints of a machine-readable presentation policy. In various embodiments, the constraint adjustment sub-engine 204f may determine whether a digital content item may be presented subject to a modified spatial region, modified presentation format, modified presentation duration, modified viewing-angle condition, modified viewing-distance condition, modified interactivity condition, modified audio-output condition, modified ambient-condition requirement, or other adjusted presentation parameter. In some embodiments, the constraint adjustment sub-engine 204f may generate a modified rendering authorization output that specifies the modified presentation parameters and may provide the modified rendering authorization output to the request interface sub-engine 204a for transmission to a rendering platform computing device 106 or augmented reality user device 102.

A rendering output generation sub-engine 204g may be configured to generate rendering authorization outputs based on outputs of the deterministic policy evaluation sub-engine 204d, semantic compatibility sub-engine 204e, constraint adjustment sub-engine 204f, or combinations thereof. In various embodiments, a rendering authorization output may indicate that presentation of a digital content item is permitted, that presentation is not permitted, that presentation is permitted subject to one or more machine-readable rendering constraints, or that presentation is permitted subject to one or more modified presentation parameters. In some embodiments, the rendering authorization output may include policy identifiers, policy version identifiers, content identifiers, spatial-region identifiers, content hashes, constraint satisfaction indicators, semantic compatibility scores, expiration times, permitted rendering regions, or other information usable by a rendering platform or augmented reality user device to control presentation of the digital content item.

A rendering token generation sub-engine 204h may be configured to generate cryptographically signed rendering tokens associated with rendering authorization outputs. In various embodiments, the rendering token generation sub-engine 204h may encode, in a rendering token, at least a portion of a rendering authorization output and one or more rendering constraints applicable to presentation of a digital content item. The rendering token may include an identifier of the digital content item, an identifier of the physical asset or spatial region, a policy version identifier, a permitted rendering region, an expiration time, a presentation-format condition, a content hash, a device-context condition, or combinations thereof. In some embodiments, the rendering token generation sub-engine 204h may generate a cryptographic signature using a private key associated with the spatial content authorization computing device 200 such that an augmented reality user device 102 or rendering platform computing device 106 may validate the rendering token using a corresponding public key.

An audit and ledger sub-engine 204i may be configured to generate, store, or transmit audit information associated with rendering authorization operations. In various embodiments, the audit and ledger sub-engine 204i may generate audit records that include request identifiers, policy identifiers, policy version identifiers, content identifiers, content hashes, rendering token identifiers, constraint satisfaction indicators, semantic compatibility scores, timestamps, cryptographic signatures, or other traceability information. In some embodiments, the audit and ledger sub-engine 204i may transmit policy hashes, rendering authorization output hashes, token identifiers, revocation indicators, or other audit information to one or more audit and ledger computing devices 114. The audit and ledger sub-engine 204i may cause such information to be stored in an audit log, append-only data store, permissioned ledger, distributed ledger, blockchain network, or hash-anchoring service.

In some embodiments, the spatial content authorization engine 204 may further include a policy lifecycle sub-engine 204j configured to support updating, versioning, signing, revocation, and distribution of machine-readable presentation policies. In various embodiments, the policy lifecycle sub-engine 204j may receive or generate policy updates, assign policy version identifiers, compute policy hashes, generate signed policy fragments, update revocation indicators, determine effective time windows, and coordinate distribution of policy records or policy fragments to augmented reality user devices 102 or rendering platform computing devices 106. In some embodiments, the policy lifecycle sub-engine 204j may support incremental policy updates or cache refresh operations that allow selected policy fragments to be updated without requiring redistribution of an entire policy dataset.

In some embodiments, the spatial content authorization engine 204 may implement a plurality of partially parallel processing paths rather than a strictly sequential pipeline. For example, the spatial content authorization engine 204 may implement a policy management path configured to receive, version, sign, and distribute machine-readable presentation policies while concurrently or asynchronously implementing a runtime authorization path that receives rendering authorization requests, evaluates request parameters against retrieved policies, and generates rendering authorization outputs. In some embodiments, semantic compatibility evaluation may be performed in parallel with deterministic policy evaluation, and audit-record generation may occur asynchronously after a rendering authorization output or rendering token has been transmitted, thereby preserving responsiveness of runtime rendering authorization operations.

The chassis 202 may also house a communication system 208 that is coupled to the spatial content authorization engine 204 via the processing system. The communication system 208 may include hardware, firmware, and software elements that enable the spatial content authorization computing device 200 to send and receive data through the network 116. In some embodiments, the communication system 208 may support encrypted communication protocols such as Transport Layer Security (TLS), Hypertext Transfer Protocol Secure (HTTPS), virtual private network tunneling, message-level encryption, mutual authentication, signed requests, or other cryptographic communication mechanisms. The communication system 208 may expose authenticated application programming interface endpoints, service interfaces, message-queue interfaces, streaming interfaces, or other communication interfaces through which augmented reality user devices 102, content source computing devices 104, rendering platform computing devices 106, policy data stores 110, artificial intelligence service computing devices 112, or audit and ledger computing devices 114 interact with the spatial content authorization computing device 200.

The chassis 202 may also include or be connected to a storage system 214 that is coupled to the spatial content authorization engine 204 through the processing system. The storage system 214 may include one or more tangible, non-transitory computer-readable media configured to store data, metadata, and intermediate processing artifacts used during operation of the spatial content authorization computing device 200. In some embodiments, the storage system 214 may include a policy metadata store 214a configured to store policy identifiers, policy version identifiers, spatial identifiers, policy hashes, signed policy fragments, effective time windows, and revocation indicators; a rendering request store 214b configured to store rendering authorization requests, extracted request parameters, request identifiers, content identifiers, spatial-context parameters, and device-context parameters; a semantic representation store 214c configured to store embeddings, content classification outputs, semantic compatibility scores, model identifiers, model version information, or other semantic evaluation data; a rendering authorization output store 214d configured to store authorization outputs, modified rendering authorization outputs, rendering constraints, rendering token identifiers, expiration times, and permitted rendering regions; and a processing and auditing log 214e configured to store audit records, cryptographic signatures, ledger transaction references, policy-evaluation traces, constraint satisfaction indicators, timestamps, and other traceability information associated with operation of the spatial content authorization computing device 200.

In some embodiments, the storage system 214 may cooperate with the policy data stores 110, artificial intelligence service computing devices 112, and audit and ledger computing devices 114 described with reference to FIG. 1, and references to storage systems or data stores should be understood to encompass local storage within the spatial content authorization computing device 200, separate shared repositories, remote storage services, ledger-based stores, or distributed storage across system components. While the storage system 214 is illustrated as a single component, one of ordinary skill in the art will recognize that the underlying data structures and storage media may be distributed, redundant, cloud-hosted, edge-hosted, or otherwise implemented without departing from the scope of the present disclosure. While a specific spatial content authorization computing device 200 is illustrated in FIG. 2, one of skill in the art in possession of the present disclosure will recognize that other configurations or spatial content authorization computing devices may fall under the scope of the present disclosure.

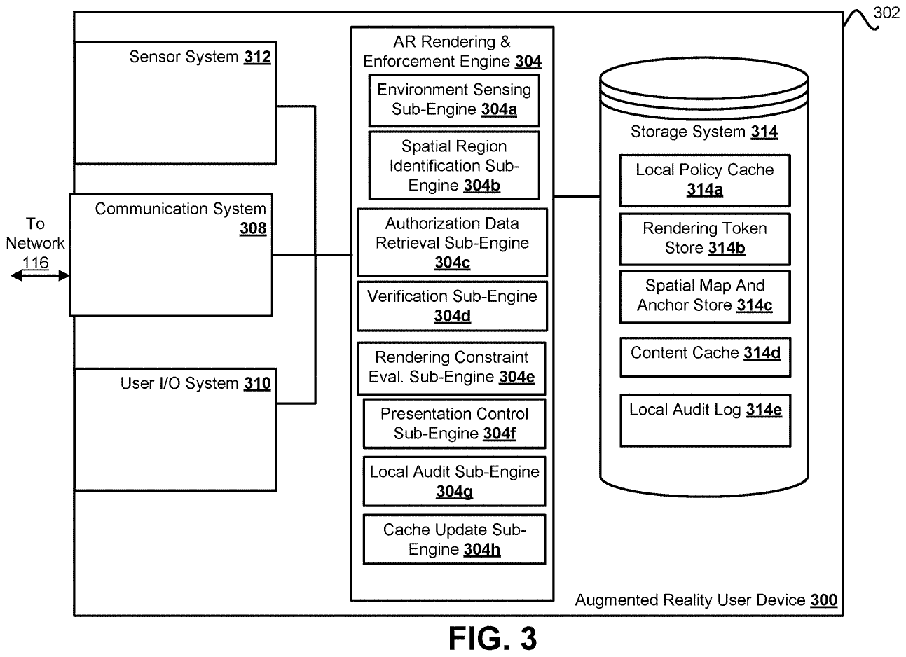

FIG. 3 illustrates an embodiment of an augmented reality user device 300 that may be one of the augmented reality user devices 102 discussed above with reference to FIG. 1. In the illustrated embodiment, the augmented reality user device 300 may include a chassis 302 that houses various components of the device. In various embodiments, the augmented reality user device 300 may be implemented as a head-mounted display, smart glasses, mobile telephone, tablet computing device, vehicle-mounted display, wearable computing device, projection system, or other computing device configured to present digital content relative to a physical environment. In some embodiments, the chassis 302 may house a processing system and a non-transitory memory system that includes instructions which, when executed by the processing system, cause the augmented reality user device 300 to provide an augmented reality rendering and enforcement engine 304.

The augmented reality rendering and enforcement engine 304 may be configured to coordinate sensing of a physical environment, identification of physical assets or spatial regions, retrieval or access of authorization data, verification of rendering tokens or signed policy fragments, evaluation of machine-readable rendering constraints, presentation control of digital content, local audit-record generation, and local cache updating. In various embodiments, the augmented reality rendering and enforcement engine 304 may include several sub-engines. An environment sensing sub-engine 304a may be configured to obtain sensor data from one or more sensors of the augmented reality user device 300. In various embodiments, the sensor data may include location data, inertial measurement data, camera data, depth-sensing data, pose data, gaze data, field of view data, ambient-light data, orientation data, proximity data, audio data, or other data associated with a physical environment of the augmented reality user device 300.

A spatial region identification sub-engine 304b may be configured to determine, based on the sensor data, a physical asset or spatial region within a field of view of the augmented reality user device 300. In various embodiments, the spatial region identification sub-engine 304b may map a pose, location, gaze direction, camera image, depth map, spatial mesh, or field of view of the augmented reality user device 300 to a geofence, parcel, façade, surface, landmark, building, spatial anchor, or other physical asset or spatial region. In some embodiments, the spatial region identification sub-engine 304b may access a local spatial map, remote spatial map, visual positioning service, simultaneous localization and mapping process, object-recognition model, marker-based localization process, or coordinate transformation process to determine an identifier associated with the physical asset or spatial region.

An authorization data retrieval sub-engine 304c may be configured to access authorization data associated with a digital content item proposed for presentation in association with the physical asset or spatial region. In various embodiments, the authorization data may include a cryptographically signed rendering token, signed policy fragment, locally cached policy record, policy version identifier, permitted spatial region, rendering constraint set, revocation indicator, expiration time, content hash, or other machine-readable data used to determine whether presentation of the digital content item is permitted. In some embodiments, the authorization data retrieval sub-engine 304c may retrieve authorization data from a local policy cache, local rendering token store, rendering platform computing device 106, spatial content authorization computing device 108, policy data store 110, or other source available through the network 116.

A verification sub-engine 304d may be configured to verify authorization data before the authorization data is used to control presentation of a digital content item. In various embodiments, the verification sub-engine 304d may validate a cryptographically signed rendering token using a public key associated with the spatial content authorization computing device 108 or the spatial content authorization computing device 200. The verification sub-engine 304d may determine whether a token signature is valid, whether a token has expired, whether a content hash encoded in the token matches the digital content item proposed for presentation, whether a policy version identifier remains valid, whether a spatial-region identifier encoded in the token corresponds to the physical asset or spatial region determined by the spatial region identification sub-engine 304b, or whether one or more device-context conditions encoded in the token are satisfied. In some embodiments, the verification sub-engine 304d may verify a signature of a signed policy fragment before local policy evaluation is performed.

A rendering constraint evaluation sub-engine 304e may be configured to determine whether presentation of the digital content item in association with the physical asset or spatial region satisfies one or more machine-readable rendering constraints. In various embodiments, the rendering constraint evaluation sub-engine 304e may evaluate constraints associated with a permitted spatial region, viewing angle, viewing distance, field of view, device pose, gaze direction, time window, ambient condition, presentation format, content classification, content hash, interactivity setting, audio-output setting, expiration time, policy version identifier, or other device-context condition. In some embodiments, the rendering constraint evaluation sub-engine 304e may evaluate constraints encoded in a cryptographically signed rendering token, constraints included in a signed policy fragment, constraints retrieved from a local policy cache, or constraints received from the spatial content authorization computing device 108.

A presentation control sub-engine 304f may be configured to control presentation of the digital content item based on the determination made by the rendering constraint evaluation sub-engine 304e. In various embodiments, the presentation control sub-engine 304f may cause the augmented reality user device 300 to apply a presentation control operation to the digital content item relative to the physical asset or spatial region. The presentation control operation may include rendering the digital content item, suppressing the digital content item, relocating the digital content item, modifying a visual characteristic of the digital content item, delaying presentation of the digital content item, substituting different digital content for the digital content item, disabling an interactive function associated with the digital content item, disabling audio output associated with the digital content item, presenting a placeholder in place of the digital content item, or combinations thereof. In some embodiments, the presentation control sub-engine 304f may interface with a graphics pipeline, compositor, scene graph, spatial rendering engine, audio renderer, user-interface layer, or application runtime of the augmented reality user device 300.

A local audit sub-engine 304g may be configured to generate local audit information associated with presentation control operations applied by the augmented reality user device 300. In various embodiments, the local audit sub-engine 304g may generate a local audit record indicating whether a digital content item was rendered, suppressed, relocated, modified, delayed, substituted, or otherwise controlled. The local audit record may include a token identifier, policy version identifier, content hash, spatial-region identifier, timestamp, presentation control operation identifier, device-generated signature, aggregate presentation indicator, privacy-preserving proof, or other traceability information. In some embodiments, the local audit record may exclude raw gaze data, raw location data, raw camera images, or other raw sensor data while preserving information sufficient to verify that one or more machine-readable rendering constraints were evaluated or enforced.

A cache update sub-engine 304h may be configured to update locally stored authorization data, rendering tokens, signed policy fragments, spatial maps, or other data used by the augmented reality user device 300. In various embodiments, the cache update sub-engine 304h may receive full policy records, signed policy fragments, incremental updates, revocation indicators, updated public keys, updated spatial anchors, or other update data from the spatial content authorization computing device 108, policy data stores 110, rendering platform computing devices 106, or other computing systems. In some embodiments, the cache update sub-engine 304h may perform cache refresh operations in response to a scheduled update, detected location change, policy version mismatch, token validation failure, revocation notification, or network availability condition. The cache update sub-engine 304h may update a local policy cache without transmitting raw gaze data or raw location data to a remote computing system.

The chassis 302 may also house a communication system 308 that is coupled to the augmented reality rendering and enforcement engine 304 via the processing system. The communication system 308 may include hardware, firmware, and software elements that enable the augmented reality user device 300 to send and receive data through the network 116. In some embodiments, the communication system 308 may include cellular communication circuitry, Wi-Fi communication circuitry, BLUETOOTH communication circuitry, ultra-wideband communication circuitry, near-field communication circuitry, satellite communication circuitry, wired communication interfaces, or combinations thereof. The communication system 308 may support encrypted communication protocols, authenticated requests, signed responses, policy-fragment downloads, rendering-token retrieval, audit-record transmission, cache updates, or other communications between the augmented reality user device 300 and one or more components of the spatial content authorization system 100.

The chassis 302 may further house a user input/output system 310 coupled to the augmented reality rendering and enforcement engine 304 via the processing system. The user input/output system 310 may include one or more output devices, input devices, or combined input/output devices configured to present information to a user or receive user input. In various embodiments, the user input/output system 310 may include a display screen, waveguide display, near-eye display, projector, optical combiner, speaker, microphone, touchscreen, keyboard, button, touchpad, haptic device, gesture-recognition interface, eye-tracking input interface, voice-input interface, or other user interface component. In some embodiments, the presentation control sub-engine 304f may cause the user input/output system 310 to present, suppress, relocate, modify, delay, substitute, or otherwise control presentation of a digital content item relative to the physical environment.

The chassis 302 may further house a sensor system 312 coupled to the augmented reality rendering and enforcement engine 304 via the processing system. The sensor system 312 may include one or more sensors configured to generate sensor data associated with a physical environment, orientation, position, motion, user gaze, or device state of the augmented reality user device 300. In various embodiments, the sensor system 312 may include one or more cameras, depth sensors, lidar sensors, time-of-flight sensors, structured-light sensors, inertial measurement units, accelerometers, gyroscopes, magnetometers, global positioning system receivers, real-time kinematic positioning receivers, Wi-Fi positioning sensors, ultra-wideband positioning sensors, barometric sensors, ambient-light sensors, proximity sensors, gaze sensors, eye-tracking sensors, microphones, biometric sensors, or combinations thereof. Sensor data generated by the sensor system 312 may be processed by the environment sensing sub-engine 304a and the spatial region identification sub-engine 304b to determine a physical asset or spatial region associated with proposed presentation of a digital content item.

The chassis 302 may also include or be connected to a storage system 314 that is coupled to the augmented reality rendering and enforcement engine 304 through the processing system. The storage system 314 may include one or more tangible, non-transitory computer-readable media configured to store data, metadata, and intermediate processing artifacts used during operation of the augmented reality user device 300. In some embodiments, the storage system 314 may include a local policy cache 314a configured to store machine-readable presentation policies, signed policy fragments, policy version identifiers, spatial identifiers, policy hashes, effective time windows, or revocation indicators; a rendering token store 314b configured to store cryptographically signed rendering tokens, token identifiers, expiration times, public-key identifiers, and token validation metadata; a spatial map and anchor store 314c configured to store spatial maps, spatial anchors, façade identifiers, geofence identifiers, parcel identifiers, surface identifiers, coordinate transforms, or other spatial-region data; a content cache 314d configured to store digital content items, content identifiers, content hashes, presentation-format metadata, or rendering assets; and a local audit log 314e configured to store local audit records, presentation control operation identifiers, aggregate presentation indicators, privacy-preserving proofs, device-generated signatures, or other traceability information.

In some embodiments, the augmented reality rendering and enforcement engine 304 may implement a plurality of partially parallel processing paths rather than a strictly sequential pipeline. For example, the augmented reality rendering and enforcement engine 304 may implement an environment-processing path that continuously or periodically obtains sensor data and updates a determined physical asset or spatial region, while concurrently implementing an authorization-verification path that accesses authorization data and validates rendering tokens or signed policy fragments. In some embodiments, the presentation control sub-engine 304f may apply presentation control operations within a rendering interval while the local audit sub-engine 304g generates local audit records asynchronously and the cache update sub-engine 304h refreshes policy fragments when network connectivity is available.

In some embodiments, the storage system 314 may cooperate with the policy data stores 110, rendering platform computing devices 106, spatial content authorization computing device 108, audit and ledger computing devices 114, or other components described with reference to FIG. 1. References to local storage, caches, stores, or logs should be understood to encompass storage within the augmented reality user device 300, removable storage, secure storage, trusted execution environment storage, remote storage accessed through the communication system 308, or distributed storage across system components. While the storage system 314 is illustrated as a single component, one of ordinary skill in the art will recognize that the underlying data structures and storage media may be distributed, redundant, encrypted, partitioned, or otherwise implemented without departing from the scope of the present disclosure. While a specific augmented reality user device 300 is illustrated in FIG. 3, one of skill in the art in possession of the present disclosure will recognize that other configurations or augmented reality user devices may fall under the scope of the present disclosure.

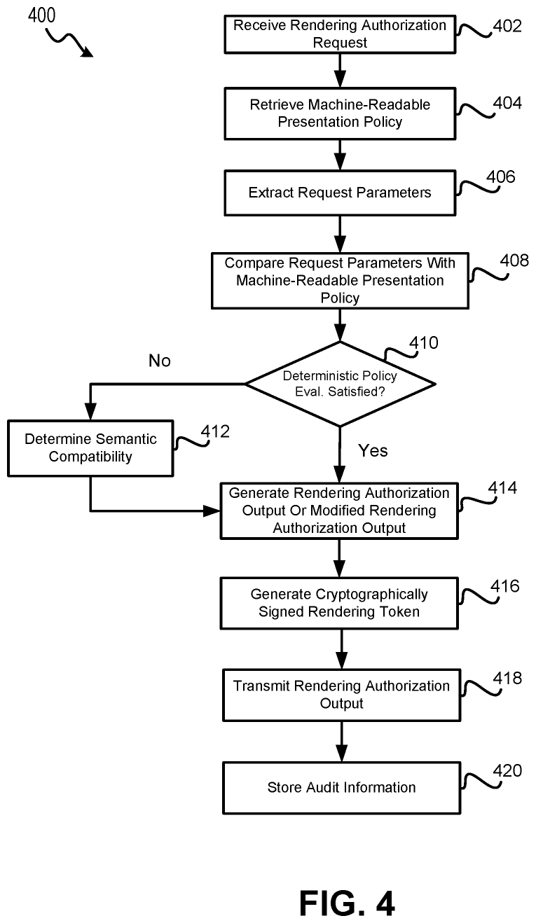

FIG. 4 illustrates an embodiment of a method 400 for generating a rendering authorization output for presentation of a digital content item in association with a physical asset or spatial region, consistent with some embodiments of the present disclosure. While a particular sequence of operations is illustrated, one of ordinary skill in the art will recognize that certain steps may be omitted, combined, reordered, or supplemented without departing from the scope of the present disclosure. The method 400 provides technological improvements to augmented reality rendering systems by evaluating machine-readable presentation policies before presentation of digital content relative to physical-world spatial contexts, thereby enabling reproducible, policy-driven, and auditable control of spatially associated digital content. In some embodiments, one or more operations illustrated in method 400 may be performed by the spatial content authorization computing device 108 of FIG. 1 or the spatial content authorization computing device 200 of FIG. 2.

The method 400 may begin at block 402 where a rendering authorization request for presenting a digital content item in an augmented reality environment is received. In various embodiments, at block 402, the request interface sub-engine 204a of the spatial content authorization engine 204 may receive, via the communication system 208 and the network 116, the rendering authorization request from a rendering platform computing device 106, a content source computing device 104, an augmented reality user device 102, or another computing system. The rendering authorization request may identify the digital content item and a physical asset or spatial region with which the digital content item is proposed to be visually associated.

In some embodiments, the rendering authorization request received at block 402 may include a request identifier, content identifier, content hash, content classification parameter, presentation-format parameter, spatial-context parameter, device-context parameter, timestamp, requested presentation duration, requested presentation count, or combinations thereof. In some embodiments, the spatial-context parameter may identify a physical asset or spatial region directly, such as by a geofence identifier, façade identifier, parcel identifier, building identifier, surface identifier, landmark identifier, or spatial-anchor identifier. In other embodiments, the spatial-context parameter may include sensor-derived context received from an augmented reality user device 102, such as device location, device pose, gaze direction, field of view, viewing angle, viewing distance, camera-derived visual features, depth-map information, spatial-mesh data, or other information from which the physical asset or spatial region may be determined.

In some embodiments, the rendering authorization request may be generated after an augmented reality user device 102 captures or determines spatial information associated with a physical environment. For example, the augmented reality user device 102 may determine a device pose and field of view using a camera, depth sensor, inertial measurement unit, location sensor, gaze sensor, or combinations thereof, and the rendering platform computing device 106 may use that information to generate the rendering authorization request. In another example, the augmented reality user device 102 may determine a façade identifier, surface identifier, geofence identifier, or spatial-anchor identifier locally and include the determined identifier in the rendering authorization request. In this manner, the rendering authorization request may provide the spatial content authorization computing device 200 with sufficient spatial context to evaluate whether the digital content item may be presented relative to the physical asset or spatial region without requiring the spatial content authorization computing device 200 to receive all raw sensor data captured by the augmented reality user device 102.

The method 400 may proceed to block 404 where a machine-readable presentation policy associated with the physical asset or spatial region is retrieved. In various embodiments, at block 404, the policy retrieval sub-engine 204b may retrieve the machine-readable presentation policy from one or more policy data stores 110, the policy metadata store 214a, or another storage system associated with the spatial content authorization system 100. The machine-readable presentation policy may specify spatial presentation constraints and content presentation constraints for digital content presented in association with the physical asset or spatial region.

In some embodiments, retrieving the machine-readable presentation policy at block 404 may include querying a policy data store using a spatial identifier included in, or derived from, the rendering authorization request. The spatial identifier may include a geofence identifier, façade identifier, parcel identifier, surface identifier, spatial-anchor identifier, coordinate range, building identifier, landmark identifier, or other identifier corresponding to a physical-world spatial context. In some embodiments, the policy retrieval sub-engine 204b may select a policy version based on an effective time window, policy status, revocation indicator, region hierarchy, surface hierarchy, confidence score, or priority value. For example, if multiple policies are associated with a building and a particular façade of that building, the policy retrieval sub-engine 204b may select the more specific façade-level policy, may merge constraints from multiple applicable policies, or may apply a precedence rule stored in the policy metadata store 214a.

In some embodiments, the machine-readable presentation policy retrieved at block 404 may include structured policy fields. By way of example, the policy may include a policy identifier, policy version identifier, spatial-region identifier, permitted content classifications, restricted content classifications, permitted presentation formats, restricted presentation formats, time windows, viewing-angle thresholds, viewing-distance thresholds, field of view conditions, ambient-condition thresholds, interactivity conditions, audio-output conditions, privacy conditions, presentation-duration limits, presentation-count limits, content-hash requirements, signature requirements, or combinations thereof. In some embodiments, the policy may be represented as a JavaScript Object Notation object, protocol buffer object, extensible markup language document, database record, signed policy fragment, graph record, vector-indexed record, or another machine-readable representation.

The method 400 may proceed to block 406 where request parameters are extracted from the rendering authorization request. In various embodiments, at block 406, the request parameter extraction sub-engine 204c may extract request parameters including at least a content classification parameter, a spatial-context parameter, and a presentation-format parameter. The extracted request parameters may be normalized into a machine-consumable representation usable by the deterministic policy evaluation sub-engine 204d, the semantic compatibility sub-engine 204e, the constraint adjustment sub-engine 204f, or combinations thereof.

In some embodiments, extracting the request parameters at block 406 may include parsing structured fields of the rendering authorization request, resolving references to stored content metadata, obtaining supplemental metadata from a content source computing device 104, or requesting additional context from a rendering platform computing device 106 or augmented reality user device 102. For example, the request parameter extraction sub-engine 204c may extract or determine a content classification parameter, presentation-format parameter, content hash, spatial-region identifier, location parameter, pose parameter, gaze parameter, field of view parameter, viewing-angle parameter, viewing-distance parameter, ambient-light parameter, interactivity parameter, audio-output parameter, requested presentation duration, requested presentation count, or device-context parameter. In some embodiments, the request parameter extraction sub-engine 204c may transform heterogeneous request formats into a canonical request representation used by the spatial content authorization engine 204.

In some embodiments, extracting request parameters may include validating that required parameters are present and assigning default or derived values when permitted by configuration data. For example, if a rendering authorization request includes a pose and coordinate range but does not include a façade identifier, the request parameter extraction sub-engine 204c may derive the façade identifier using a spatial map, visual positioning service output, or policy data store lookup. If a request includes a content identifier but not a content hash, the request parameter extraction sub-engine 204c may retrieve or compute the content hash using content metadata provided by the content source computing device 104. The request parameter extraction sub-engine 204c may store the extracted request parameters, derived values, validation results, and request identifier in the rendering request store 214b to support traceability of the authorization operation.

The method 400 may proceed to block 408 where the request parameters are compared with the machine-readable presentation policy. In various embodiments, at block 408, the deterministic policy evaluation sub-engine 204d may compare the request parameters extracted at block 406 with spatial presentation constraints and content presentation constraints of the machine-readable presentation policy retrieved at block 404. The comparison may determine whether the rendering authorization request satisfies one or more deterministic constraints applicable to presentation of the digital content item in association with the physical asset or spatial region.

In some embodiments, comparing the request parameters with the machine-readable presentation policy may include evaluating a plurality of policy conditions. For example, the deterministic policy evaluation sub-engine 204d may determine whether the spatial-context parameter corresponds to a permitted geofence, façade, parcel, surface, landmark, or spatial anchor; whether a viewing angle or viewing distance satisfies a threshold; whether a proposed presentation time falls within an effective time window; whether the presentation-format parameter corresponds to a permitted format; whether an interactivity setting or audio-output setting is permitted; whether an ambient-light condition satisfies an ambient-condition constraint; whether the content classification parameter satisfies a content presentation constraint; whether a requested presentation duration or presentation count satisfies a policy limit; or whether a device-context condition is satisfied. In some embodiments, the deterministic policy evaluation sub-engine 204d may generate a constraint satisfaction vector identifying, for each evaluated policy condition, whether the corresponding condition is satisfied, not satisfied, not applicable, or inconclusive.

In some embodiments, deterministic policy evaluation may be performed using structured comparisons, range checks, Boolean logic, set-membership operations, geospatial containment operations, surface-identifier matching, time-window comparisons, threshold comparisons, or combinations thereof. For example, a geospatial containment operation may determine whether a device location or proposed presentation coordinate falls within an authorized geofence. A viewing-angle comparison may determine whether a normal vector associated with a façade and a gaze or camera vector associated with the augmented reality user device 102 satisfy an angular threshold. A content-hash comparison may determine whether a content hash included in the rendering authorization request matches a hash associated with an approved version of the digital content item. The deterministic policy evaluation sub-engine 204d may store evaluation results in the processing and auditing log 214e.

The method 400 may proceed to decision block 410 where a determination is made regarding whether deterministic policy evaluation is satisfied or whether semantic evaluation is to be performed. In various embodiments, at decision block 410, the spatial content authorization engine 204 may determine whether the request parameters satisfy the machine-readable presentation policy based on the deterministic policy evaluation performed at block 408. If the deterministic policy evaluation indicates that the rendering authorization request satisfies the applicable spatial presentation constraints and content presentation constraints, the method 400 may proceed toward generation of a rendering authorization output. If one or more policy conditions are not satisfied or are inconclusive, the method 400 may proceed to semantic evaluation, constraint adjustment, denial generation, or combinations thereof.

In some embodiments, semantic evaluation may be invoked when a content classification parameter does not exactly match a policy field, when a digital content item includes unstructured text, image content, audio content, or multimodal content requiring classification, or when a policy condition is expressed at a semantic level rather than as a simple enumerated field. For example, the machine-readable presentation policy may include a permitted or restricted semantic category, and the rendering authorization request may include metadata, text, image features, or other content attributes that do not map exactly to the policy category. In such cases, the spatial content authorization engine 204 may route the digital content item or associated metadata to the semantic compatibility sub-engine 204e to determine whether the digital content item is semantically compatible with the machine-readable presentation policy.

The method 400 may proceed to block 412 where semantic compatibility between the digital content item and the machine-readable presentation policy is determined. In various embodiments, at block 412, the semantic compatibility sub-engine 204e may generate or obtain a semantic representation of at least one of the digital content item or metadata associated with the digital content item and may compare the semantic representation with a semantic representation of at least a portion of the machine-readable presentation policy. Based on the comparison, the semantic compatibility sub-engine 204e may determine whether the digital content item satisfies a policy condition expressed by, or associated with, the machine-readable presentation policy.

In some embodiments, determining semantic compatibility at block 412 may include providing text, image data, audio data, metadata, or multimodal feature data associated with the digital content item to an artificial intelligence service computing device 112. The artificial intelligence service computing device 112 may return an embedding, classification output, similarity score, multimodal content classification, or other model output. In some embodiments, the semantic compatibility sub-engine 204e may compute a similarity score between an embedding associated with the digital content item and an embedding associated with a policy category, policy description, policy constraint, or policy rule. The semantic compatibility sub-engine 204e may determine that the digital content item satisfies a semantic policy condition when the similarity score satisfies a threshold, and may determine that the digital content item does not satisfy the semantic policy condition when the similarity score fails to satisfy the threshold.

In some embodiments, semantic compatibility evaluation may be performed using a controlled evaluation pipeline rather than an unconstrained generative decision. For example, the semantic compatibility sub-engine 204e may generate a content representation, compare the content representation with one or more stored policy representations, apply a similarity threshold or classifier output threshold, and store the model identifier, model version, threshold, similarity score, and resulting compatibility indicator in the semantic representation store 214c or processing and auditing log 214e. In some embodiments, the semantic compatibility sub-engine 204e may combine semantic compatibility results with deterministic policy evaluation results to produce a hybrid evaluation output. For instance, a rendering authorization request may be denied if a deterministic spatial constraint is not satisfied regardless of semantic compatibility, while a semantic compatibility result may resolve an otherwise inconclusive content classification constraint.

The method 400 may proceed to block 414 where a rendering authorization output or modified rendering authorization output is generated. In various embodiments, at block 414, the rendering output generation sub-engine 204g may generate a rendering authorization output based on the deterministic policy evaluation, the semantic compatibility evaluation, the constraint satisfaction vector, or combinations thereof. The rendering authorization output may specify whether the digital content item is permitted to be presented in association with the physical asset or spatial region.

In some embodiments, when the deterministic policy evaluation and any semantic compatibility evaluation indicate that the applicable constraints are satisfied, the rendering output generation sub-engine 204g may generate a rendering authorization output indicating that presentation is permitted. When one or more constraints are not satisfied, the rendering output generation sub-engine 204g may generate a rendering authorization output indicating that presentation is not permitted. In some embodiments, before generating a denial output, the constraint adjustment sub-engine 204f may determine whether one or more modified presentation parameters would cause the rendering authorization request to satisfy the machine-readable presentation policy. For example, the constraint adjustment sub-engine 204f may identify a modified spatial region, modified presentation format, modified presentation duration, modified viewing-angle condition, modified viewing-distance condition, modified interactivity condition, modified audio-output condition, or modified ambient-condition requirement under which presentation would be permitted.

In some embodiments, the modified rendering authorization output may specify a machine-readable set of adjusted presentation parameters. For example, the modified rendering authorization output may indicate that a digital content item is permitted only if presented without audio output, only if displayed outside a restricted surface area, only if presented at a reduced visual size, only if an interactive function is disabled, only during a specified time window, only when a viewing distance exceeds a threshold, or only when a content hash matches an approved version. In some embodiments, the rendering output generation sub-engine 204g may store the rendering authorization output, modified rendering authorization output, constraint satisfaction indicators, semantic compatibility scores, and related decision metadata in the rendering authorization output store 214d.

The method 400 may proceed to block 416 where a cryptographically signed rendering token is generated. In various embodiments, at block 416, the rendering token generation sub-engine 204h may generate a cryptographically signed rendering token that encodes at least a portion of the rendering authorization output and one or more rendering constraints applicable to presentation of the digital content item. The cryptographically signed rendering token may be configured for local validation by a rendering platform computing device 106, augmented reality user device 102, or other rendering system without requiring the rendering system to repeat all evaluation operations performed by the spatial content authorization computing device 200.

In some embodiments, the cryptographically signed rendering token may include a token identifier, request identifier, content identifier, content hash, physical asset identifier, spatial-region identifier, policy identifier, policy version identifier, permitted rendering region, expiration time, presentation-format condition, device-context condition, presentation-duration condition, presentation-count condition, semantic compatibility indicator, or constraint satisfaction indicator. The rendering token generation sub-engine 204h may sign the rendering token using a private key associated with the spatial content authorization computing device 200. In some embodiments, the rendering token may be represented as a signed structured object, signed JavaScript Object Notation web token, signed binary token, verifiable credential, signed policy-attestation object, or another cryptographically verifiable data structure. A corresponding public key may be made available to an augmented reality user device 102 or rendering platform computing device 106 to verify the token before presentation occurs.

The method 400 may proceed to block 418 where the rendering authorization output is transmitted to an augmented reality rendering system. In various embodiments, at block 418, the request interface sub-engine 204a may transmit, via the communication system 208 and the network 116, the rendering authorization output to a rendering platform computing device 106, augmented reality user device 102, content source computing device 104, or another augmented reality rendering system configured to control presentation of the digital content item. The rendering authorization output may include an authorization indicator, denial indicator, modified rendering authorization output, cryptographically signed rendering token, machine-readable rendering constraints, or combinations thereof.

In some embodiments, transmitting the rendering authorization output at block 418 may include transmitting different portions of the output to different components of the spatial content authorization system 100. For example, a rendering platform computing device 106 may receive a rendering authorization output identifying whether the digital content item is permitted and may forward a cryptographically signed rendering token to an augmented reality user device 102. In another example, the augmented reality user device 102 may receive the rendering token directly from the spatial content authorization computing device 108 and may validate the rendering token locally before applying a presentation control operation. In some embodiments, the rendering authorization output may cause the augmented reality user device 102 to render the digital content item, suppress the digital content item, relocate the digital content item, modify a visual characteristic of the digital content item, delay presentation of the digital content item, substitute different digital content, disable an interactive function, disable audio output, or present a placeholder.

The method 400 may proceed to block 420 where audit information associated with the rendering authorization output is stored. In various embodiments, at block 420, the audit and ledger sub-engine 204i may store an audit record associated with the rendering authorization output in the processing and auditing log 214e, an audit and ledger computing device 114, or another storage system. The audit record may include a hash of the machine-readable presentation policy, policy version identifier, request identifier, content identifier, content hash, spatial-region identifier, token identifier, timestamp, cryptographic signature, rendering authorization output hash, semantic compatibility score, constraint satisfaction indicator, distributed-ledger transaction reference, or combinations thereof.

In some embodiments, storing the audit information at block 420 may include anchoring at least a portion of the audit information to an append-only log, permissioned ledger, distributed ledger, blockchain network, or hash-anchoring service. For example, the audit and ledger sub-engine 204i may transmit a policy hash, rendering authorization output hash, token identifier, or policy version reference to an audit and ledger computing device 114. In some embodiments, the audit record may exclude raw gaze data, raw location data, raw camera images, or other raw sensor data while preserving sufficient information to verify that a particular rendering authorization output corresponded to a particular policy version, content identifier, and spatial-region identifier. In some embodiments, audit information may be stored synchronously before transmitting the rendering authorization output, while in other embodiments audit information may be stored asynchronously after the rendering authorization output or rendering token has been transmitted to reduce latency in runtime rendering workflows.

In some embodiments, the operations described above with respect to method 400 may be implemented using structured policy and request objects. For example, a rendering authorization request may include fields corresponding to a request identifier, content identifier, content hash, content classification, presentation format, spatial-region identifier, pose vector, gaze vector, field of view, viewing distance, ambient condition, interactivity flag, audio-output flag, requested duration, and requested presentation count. A machine-readable presentation policy may include fields corresponding to a policy identifier, policy version, spatial-region identifier, allowed or restricted content classifications, allowed or restricted presentation formats, viewing-angle thresholds, viewing-distance thresholds, temporal windows, device-context conditions, interactivity conditions, audio-output conditions, presentation-duration limits, presentation-count limits, and signature metadata. In some embodiments, pseudocode corresponding to method 400 may include retrieving a policy by spatial-region identifier, normalizing request fields, evaluating deterministic constraints, invoking semantic evaluation for inconclusive content conditions, generating a modified authorization when adjustment rules are satisfied, signing an authorization token, and storing an audit record.

The operations described above with reference to method 400 are provided by way of example and not limitation. Although the method 400 is illustrated as including a particular sequence of operations and decision points, one of ordinary skill in the art will recognize that certain steps may be omitted, combined, reordered, or supplemented without departing from the scope of the present disclosure. In various embodiments, portions of method 400 may be executed by different computing devices, engines, or services operating in distributed, cloud-based, edge-based, or hybrid computing environments. Additional embodiments may incorporate alternative spatial-identification techniques, policy-retrieval techniques, deterministic evaluation techniques, semantic compatibility techniques, token-generation techniques, audit-storage techniques, or presentation-control techniques and may be adapted to different augmented reality devices, rendering platforms, policy schemas, spatial data structures, or content formats. Accordingly, the techniques described herein should be understood as illustrative and not limiting, and may be modified, extended, or combined while remaining within the scope of the appended claims.

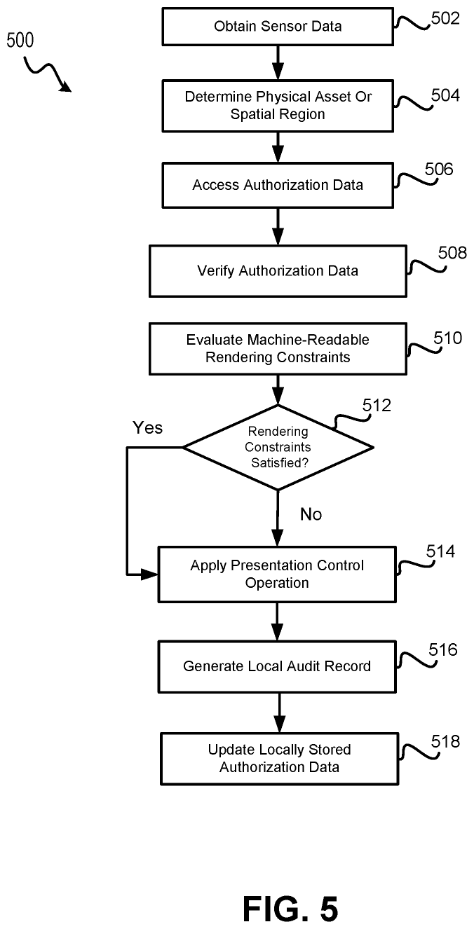

FIG. 5 illustrates an embodiment of a method 500 for controlling presentation of a digital content item by an augmented reality user device, consistent with some embodiments of the present disclosure. While a particular sequence of operations is illustrated, one of ordinary skill in the art will recognize that certain steps may be omitted, combined, reordered, or supplemented without departing from the scope of the present disclosure. The method 500 provides technological improvements to augmented reality user devices by enabling local or partially local verification of authorization data before presentation of digital content relative to a physical asset or spatial region, thereby reducing network dependency, lowering rendering latency, preserving device-context privacy, and improving consistency of machine-readable rendering-constraint enforcement. In some embodiments, one or more operations illustrated in method 500 may be performed by the augmented reality user device 102 of FIG. 1 or the augmented reality user device 300 of FIG. 3.

The method 500 may begin at block 502 where sensor data associated with a physical environment of an augmented reality user device is obtained. In various embodiments, at block 502, the environment sensing sub-engine 304a of the augmented reality rendering and enforcement engine 304 may obtain sensor data from the sensor system 312 of the augmented reality user device 300. The sensor data may include information usable to determine a device pose, field of view, spatial map, object location, surface location, gaze direction, ambient condition, or other context associated with the physical environment of the augmented reality user device 300.

In some embodiments, obtaining the sensor data at block 502 may include receiving data from one or more cameras, depth sensors, lidar sensors, time-of-flight sensors, structured-light sensors, inertial measurement units, accelerometers, gyroscopes, magnetometers, global positioning system receivers, real-time kinematic positioning receivers, Wi-Fi positioning sensors, ultra-wideband positioning sensors, barometric sensors, ambient-light sensors, proximity sensors, gaze sensors, eye-tracking sensors, microphones, or combinations thereof. In some embodiments, the environment sensing sub-engine 304a may obtain raw sensor data, filtered sensor data, fused sensor data, derived pose data, or a device-context object generated by a sensor-fusion pipeline of the augmented reality user device 300.

In some embodiments, obtaining the sensor data at block 502 may include generating or updating a spatial understanding of the physical environment. For example, the augmented reality user device 300 may perform simultaneous localization and mapping, visual-inertial odometry, depth-map generation, surface-plane detection, object recognition, marker recognition, visual positioning, geospatial localization, or coordinate-frame alignment using the sensor data. In some embodiments, raw camera images, raw gaze data, or raw location data may remain on the augmented reality user device 300, while derived spatial identifiers, pose estimates, field of view parameters, or constraint-evaluation values are used for subsequent authorization or rendering operations.

The method 500 may proceed to block 504 where a physical asset or spatial region within a field of view of the augmented reality user device is determined. In various embodiments, at block 504, the spatial region identification sub-engine 304b may determine, based on the sensor data obtained at block 502, a physical asset or spatial region associated with a proposed presentation of a digital content item. The physical asset or spatial region may include a geofence, parcel, façade, surface, landmark, building, spatial anchor, coordinate region, object boundary, display region, or other physical-world context relative to which the digital content item may be presented.

In some embodiments, determining the physical asset or spatial region at block 504 may include mapping a pose or location of the augmented reality user device 300 to a spatial identifier. For example, the spatial region identification sub-engine 304b may use a device location, camera pose, gaze vector, field of view, depth map, or spatial mesh to determine that a particular façade, surface, parcel, building, landmark, or spatial anchor is within a field of view of the augmented reality user device 300. In some embodiments, the spatial region identification sub-engine 304b may access the spatial map and anchor store 314c to map local coordinates to a geospatial coordinate system, map a detected surface to a stored surface identifier, or map a recognized visual feature to a known physical asset identifier.

In some embodiments, determining the physical asset or spatial region at block 504 may include resolving ambiguity among multiple candidate spatial regions. For example, a field of view of the augmented reality user device 300 may include multiple surfaces, overlapping geofences, adjacent parcels, or multiple façade segments. The spatial region identification sub-engine 304b may select a target physical asset or spatial region based on a gaze intersection, ray-cast result, surface normal, depth ordering, occlusion state, distance threshold, confidence score, policy priority, rendering target specified by an application, or combinations thereof. In some embodiments, the spatial region identification sub-engine 304b may store a selected spatial-region identifier, confidence score, pose estimate, or mapping result in the spatial map and anchor store 314c or local audit log 314e.

The method 500 may proceed to block 506 where authorization data associated with a digital content item proposed for presentation in association with the physical asset or spatial region is accessed. In various embodiments, at block 506, the authorization data retrieval sub-engine 304c may access authorization data associated with the digital content item and the physical asset or spatial region determined at block 504. The authorization data may include a cryptographically signed rendering token, signed policy fragment, locally cached policy record, rendering constraint set, policy version identifier, spatial-region identifier, permitted rendering region, revocation indicator, expiration time, content hash, public-key identifier, or combinations thereof.

In some embodiments, accessing the authorization data at block 506 may include retrieving a signed policy fragment from the local policy cache 314a of the augmented reality user device 300. The signed policy fragment may be associated with the physical asset or spatial region determined at block 504 and may include one or more machine-readable rendering constraints applicable to digital content presented relative to that physical asset or spatial region. In some embodiments, the authorization data retrieval sub-engine 304c may select the signed policy fragment using a geofence identifier, parcel identifier, façade identifier, surface identifier, spatial-anchor identifier, building identifier, landmark identifier, or other spatial identifier.

In some embodiments, accessing the authorization data at block 506 may include obtaining a cryptographically signed rendering token associated with the digital content item. The cryptographically signed rendering token may have been generated by the spatial content authorization computing device 108 or 200 and may be received from the rendering platform computing device 106, spatial content authorization computing device 108, content source computing device 104, or another computing system through the communication system 308. In some embodiments, the token may already be stored in the rendering token store 314b when the digital content item is selected for presentation. In other embodiments, the authorization data retrieval sub-engine 304c may request the token in response to determining the physical asset or spatial region at block 504.

In some embodiments, accessing authorization data at block 506 may include accessing both locally stored authorization data and remotely obtained authorization data. For example, the augmented reality user device 300 may retrieve a local signed policy fragment from the local policy cache 314a and obtain a cryptographically signed rendering token from the rendering platform computing device 106. The augmented reality user device 300 may then evaluate whether the token conditions and the locally cached policy conditions are mutually consistent. In some embodiments, if authorization data is unavailable locally and a network connection is unavailable, the augmented reality user device 300 may apply a default presentation control operation, such as suppressing presentation, delaying presentation, presenting a placeholder, or presenting only content previously authorized for offline use.

The method 500 may proceed to block 508 where authorization data is verified. In various embodiments, at block 508, the verification sub-engine 304d may verify a cryptographically signed rendering token, signed policy fragment, or other authorization data before the authorization data is used to control presentation of the digital content item. The verification may determine whether the authorization data was generated by an authorized computing system, has not been altered after issuance, remains valid for a current policy version, and corresponds to the digital content item and physical asset or spatial region associated with the proposed presentation.

In some embodiments, verifying authorization data at block 508 may include validating a cryptographic signature using a public key associated with the spatial content authorization computing device 108 or 200. For example, the verification sub-engine 304d may validate a token signature, validate a signature of a signed policy fragment, verify a certificate chain, verify a public-key identifier, or verify that a key has not been revoked. In some embodiments, the verification sub-engine 304d may determine whether a token identifier, policy version identifier, or policy-fragment identifier is associated with a revocation indicator stored in the local policy cache 314a, rendering token store 314b, or received from the spatial content authorization computing device 108.

In some embodiments, verifying authorization data at block 508 may include determining whether token or policy-fragment fields correspond to the proposed presentation. For example, the verification sub-engine 304d may determine whether a content hash encoded in a cryptographically signed rendering token matches a content hash of the digital content item stored in the content cache 314d, whether a spatial-region identifier encoded in the token matches the physical asset or spatial region determined at block 504, whether an expiration time has not elapsed, whether a policy version identifier remains current, or whether a permitted rendering region includes the location or surface on which the digital content item is proposed to be presented. Verification results may be stored as validation metadata in the rendering token store 314b or local audit log 314e.

The method 500 may proceed to block 510 where a determination is made regarding whether presentation of the digital content item satisfies one or more machine-readable rendering constraints. In various embodiments, at block 510, the rendering constraint evaluation sub-engine 304e may determine, based on the authorization data accessed at block 506 and verified at block 508, whether presentation of the digital content item in association with the physical asset or spatial region satisfies one or more machine-readable rendering constraints. The machine-readable rendering constraints may be encoded in a cryptographically signed rendering token, signed policy fragment, locally cached policy record, rendering authorization output, or combinations thereof.

In some embodiments, determining whether presentation satisfies the one or more machine-readable rendering constraints may include evaluating spatial constraints, device-context constraints, content constraints, or presentation constraints. For example, the rendering constraint evaluation sub-engine 304e may determine whether a device pose, gaze direction, field of view, viewing angle, viewing distance, ambient-light value, time value, content hash, content classification, presentation format, interactivity setting, audio-output setting, presentation duration, presentation count, expiration time, or policy version identifier satisfies a corresponding constraint encoded in the authorization data. In some embodiments, the rendering constraint evaluation sub-engine 304e may generate a constraint satisfaction vector identifying which constraints are satisfied, not satisfied, not applicable, or inconclusive.

In some embodiments, the rendering constraint evaluation sub-engine 304e may evaluate constraints repeatedly or continuously during a rendering session. For example, a digital content item may initially satisfy a viewing-angle constraint or viewing-distance constraint, but the augmented reality user device 300 may move such that the constraint is no longer satisfied. The rendering constraint evaluation sub-engine 304e may reevaluate the machine-readable rendering constraints based on updated sensor data obtained from the sensor system 312 and may provide updated constraint satisfaction indicators to the presentation control sub-engine 304f. In this manner, presentation of the digital content item may be dynamically controlled as the physical environment, device pose, gaze direction, or field of view changes.

The method 500 may proceed to decision block 512 where a determination is made regarding whether the one or more machine-readable rendering constraints are satisfied. In various embodiments, at decision block 512, the augmented reality rendering and enforcement engine 304 may determine whether presentation of the digital content item is permitted based on the constraint evaluation performed at block 510. If the one or more machine-readable rendering constraints are satisfied, the method 500 may proceed to apply a presentation control operation that permits presentation of the digital content item. If one or more of the machine-readable rendering constraints are not satisfied, expired, invalid, revoked, or inconclusive, the method 500 may proceed to apply a presentation control operation that suppresses, modifies, delays, relocates, substitutes, or otherwise controls presentation of the digital content item.

In some embodiments, the determination at decision block 512 may be based on a policy mode, fallback rule, device state, rendering context, or constraint priority. For example, failure of a content-hash constraint, signature-verification constraint, or spatial-region constraint may cause presentation to be suppressed, while failure of an audio-output constraint may cause audio output to be disabled while visual presentation remains permitted. In another example, failure of a viewing-distance constraint may cause the digital content item to be relocated or resized, and failure of an interactivity constraint may cause an interactive function to be disabled. In some embodiments, different presentation control operations may be selected based on which constraint failed and whether the authorization data specifies a permitted fallback operation.

The method 500 may proceed to block 514 where presentation of the digital content item is controlled by applying a presentation control operation. In various embodiments, at block 514, the presentation control sub-engine 304f may control presentation of the digital content item by causing the augmented reality user device 300 to apply a presentation control operation to the digital content item relative to the physical asset or spatial region. The presentation control operation may be selected based on the determination at decision block 512 and may be applied through a graphics pipeline, compositor, scene graph, spatial rendering engine, audio renderer, user-interface layer, application runtime, or user input/output system 310 of the augmented reality user device 300.

In some embodiments, applying the presentation control operation at block 514 may include rendering the digital content item when the machine-readable rendering constraints are satisfied. Rendering the digital content item may include presenting a two-dimensional image, three-dimensional object, volumetric object, video object, text object, audio object, interactive object, animation, overlay, or other digital content item relative to the physical asset or spatial region. In some embodiments, the presentation control sub-engine 304f may anchor the digital content item to a spatial anchor, align the digital content item with a detected surface, position the digital content item within a permitted rendering region, or adjust the digital content item based on occlusion, depth, lighting, or perspective information associated with the physical environment.

In some embodiments, applying the presentation control operation at block 514 may include suppressing the digital content item, relocating the digital content item, modifying a visual characteristic of the digital content item, delaying presentation of the digital content item, substituting different digital content for the digital content item, disabling an interactive function associated with the digital content item, disabling audio output associated with the digital content item, presenting a placeholder in place of the digital content item, or combinations thereof. Modifying a visual characteristic may include resizing, cropping, dimming, blurring, changing opacity, modifying color, modifying animation behavior, changing orientation, changing depth placement, changing occlusion behavior, or changing a spatial anchor. In some embodiments, presenting a placeholder may include presenting a neutral visual object, presenting a blank region, presenting a boundary indicator, presenting an unavailable-content indicator, or reserving a rendering region without presenting the digital content item.

In some embodiments, presentation control at block 514 may be performed without transmitting raw sensor data from the augmented reality user device 300. For example, the augmented reality user device 300 may use locally obtained gaze data, pose data, camera data, or location data to evaluate machine-readable rendering constraints and may apply a presentation control operation locally. The augmented reality user device 300 may transmit only a token identifier, policy version identifier, aggregate presentation indicator, privacy-preserving proof, or other limited audit information after the presentation control operation is applied. This may reduce network bandwidth and preserve privacy of raw device-context data while still allowing verification of rendering-constraint enforcement.

The method 500 may proceed to block 516 where a local audit record is generated. In various embodiments, at block 516, the local audit sub-engine 304g may generate a local audit record indicating the presentation control operation applied to the digital content item. The local audit record may be stored in the local audit log 314e, transmitted to the spatial content authorization computing device 108, transmitted to an audit and ledger computing device 114, or retained locally until a network connection becomes available.

In some embodiments, the local audit record generated at block 516 may include a token identifier, policy version identifier, content hash, spatial-region identifier, timestamp, presentation control operation identifier, device-generated signature, aggregate presentation indicator, privacy-preserving proof, constraint satisfaction indicator, or combinations thereof. In some embodiments, the local audit record may exclude raw gaze data, raw location data, raw camera images, raw depth data, or other raw sensor data. In one example, the local audit record may indicate that a verified token associated with a particular policy version caused a digital content item to be rendered, suppressed, relocated, modified, delayed, substituted, or otherwise controlled, without exposing the raw sensor data used by the augmented reality user device 300 to evaluate one or more rendering constraints.

In some embodiments, the local audit sub-engine 304g may batch, compress, sign, or encrypt local audit records before transmitting the local audit records to another computing system. For example, the local audit sub-engine 304g may aggregate multiple presentation control events into a batch audit report, generate a device signature for the batch audit report, and transmit the batch audit report to the spatial content authorization computing device 108 or audit and ledger computing device 114. In some embodiments, the local audit sub-engine 304g may store audit records locally when the augmented reality user device 300 is offline and may transmit selected audit records or aggregate indicators when connectivity is restored.

The method 500 may proceed to block 518 where locally stored authorization data is updated. In various embodiments, at block 518, the cache update sub-engine 304h may update a local policy cache, rendering token store, spatial map and anchor store, content cache, local audit log, or combinations thereof based on the presentation control operation, authorization-data verification result, policy version information, or network-available update information. Updating the locally stored authorization data may allow the augmented reality user device 300 to perform subsequent authorization and rendering-constraint evaluations with reduced latency and reduced network communication.

In some embodiments, updating locally stored authorization data at block 518 may include receiving a full policy record, signed policy fragment, incremental policy update, revocation indicator, updated public key, updated token, updated spatial anchor, or other update data from the spatial content authorization computing device 108, policy data store 110, rendering platform computing device 106, or another computing system. In some embodiments, the cache update sub-engine 304h may update the local policy cache 314a based on a detected policy version mismatch, expired token, invalid signature, location change, scheduled refresh interval, policy-fragment expiration, or revocation notification. In some embodiments, update data may be provided as a delta update or Merkle-tree-based update so that the augmented reality user device 300 updates selected policy fragments without downloading an entire policy dataset.

In some embodiments, updating locally stored authorization data at block 518 may include maintaining consistency between a local policy cache and remotely maintained policy data. For example, the cache update sub-engine 304h may compare a locally stored policy version identifier with a current policy version identifier received from the spatial content authorization computing device 108 or policy data store 110. If the local policy version is stale, the cache update sub-engine 304h may retrieve an updated signed policy fragment corresponding to the physical asset or spatial region. If a token is expired or revoked, the cache update sub-engine 304h may remove the token from the rendering token store 314b or mark the token unavailable for subsequent presentation. Such cache update operations may improve offline or low-connectivity operation while reducing the risk that stale authorization data will be used during rendering.

In some embodiments, the operations described above with respect to method 500 may be performed in a continuous, repeated, or partially parallel manner during operation of the augmented reality user device 300. For example, the environment sensing sub-engine 304a and spatial region identification sub-engine 304b may continuously update a physical asset or spatial region as a user moves the augmented reality user device 300, while the verification sub-engine 304d and rendering constraint evaluation sub-engine 304e evaluate tokens or signed policy fragments associated with digital content items selected for presentation. The presentation control sub-engine 304f may apply presentation control operations within a rendering interval, while the local audit sub-engine 304g and cache update sub-engine 304h perform audit and update operations asynchronously.

In some embodiments, the operations described above with respect to method 500 may be used with structured authorization data and local policy data. For example, a cryptographically signed rendering token may include fields corresponding to a token identifier, content identifier, content hash, policy version identifier, spatial-region identifier, permitted rendering region, expiration time, presentation-format condition, device-context condition, presentation-duration condition, presentation-count condition, and signature. A signed policy fragment may include fields corresponding to a policy identifier, policy version identifier, spatial-region identifier, permitted content classifications, permitted presentation formats, viewing-angle constraints, viewing-distance constraints, interactivity constraints, audio-output constraints, temporal windows, and signature metadata. In some embodiments, pseudocode corresponding to method 500 may include determining a spatial-region identifier from sensor data, retrieving a token and signed policy fragment, verifying signatures, checking expiration and content hash, evaluating spatial and presentation constraints, applying a presentation control operation, and generating a local audit record.

The operations described above with reference to method 500 are provided by way of example and not limitation. Although method 500 is illustrated as including a particular sequence of operations and decision points, one of ordinary skill in the art will recognize that certain steps may be omitted, combined, reordered, or supplemented without departing from the scope of the present disclosure. In various embodiments, portions of method 500 may be executed by different components of the augmented reality user device 300, by a rendering platform computing device 106, by the spatial content authorization computing device 108, by an edge computing device, or by combinations thereof. Additional embodiments may incorporate alternative sensing techniques, spatial-region identification techniques, token verification techniques, signed-policy-fragment techniques, rendering constraint evaluation techniques, presentation control operations, audit-record-generation techniques, or cache update techniques and may be adapted to different augmented reality devices, rendering platforms, policy schemas, spatial maps, content formats, or connectivity conditions. Accordingly, the techniques described herein should be understood as illustrative and not limiting, and may be modified, extended, or combined while remaining within the scope of the appended claims.

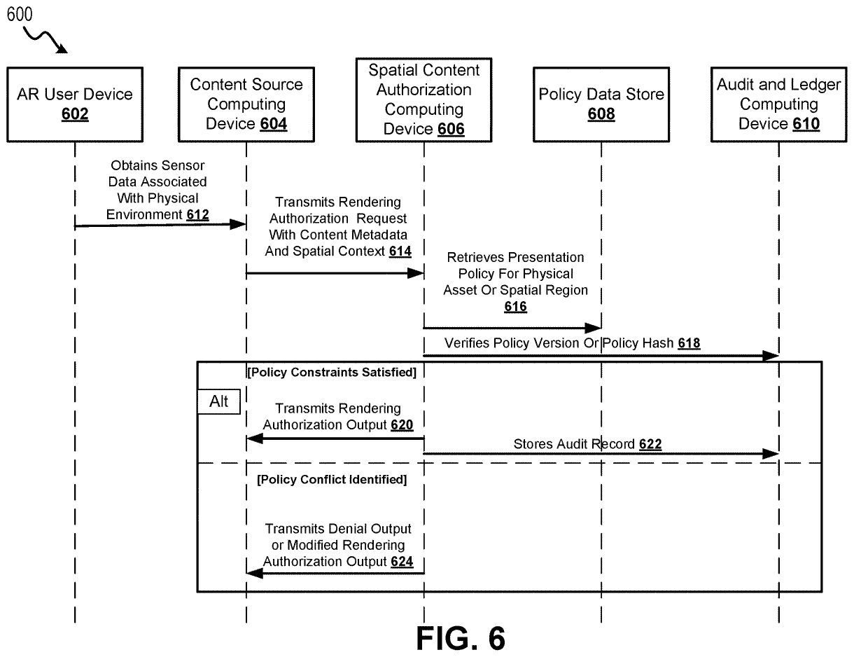

FIG. 6 illustrates an embodiment of a spatial content authorization request flow 600, consistent with some embodiments of the present disclosure. The spatial content authorization request flow 600 may be implemented using one or more components of the spatial content authorization system 100 described with reference to FIG. 1, including an augmented reality user device 602, a content source computing device 604, a spatial content authorization computing device 606, a policy data store 608, and an audit and ledger computing device 610. In some embodiments, the augmented reality user device 602 may correspond to one of the augmented reality user devices 102 or the augmented reality user device 300, the content source computing device 604 may correspond to one of the content source computing devices 104, the spatial content authorization computing device 606 may correspond to the spatial content authorization computing device 108 or 200, the policy data store 608 may correspond to one of the policy data stores 110, and the audit and ledger computing device 610 may correspond to one of the audit and ledger computing devices 114.

The spatial content authorization request flow 600 may begin at operation 612 where sensor data associated with a physical environment is obtained. In various embodiments, at operation 612, the augmented reality user device 602 may capture or generate spatial-context information associated with an augmented reality scene. The spatial-context information may include a device location, device pose, gaze direction, field of view, viewing angle, viewing distance, ambient condition, camera-derived visual features, depth-map information, spatial-mesh information, spatial-anchor identifier, façade identifier, building identifier, geofence identifier, parcel identifier, surface identifier, or other information usable to determine a physical asset or spatial region with which a digital content item may be visually associated.

In some embodiments, operation 612 may correspond to the user-scene interaction described in connection with the provisional request flow, where a user engages with or views an augmented or extended reality scene and the interaction triggers conditions under which digital content may be rendered in the user's environment. In the present disclosure, such interaction is described in broader technical terms as the augmented reality user device 602 obtaining sensor data and determining spatial context associated with a physical environment. The sensor data or derived spatial context may be processed locally by the augmented reality user device 602, provided to a rendering platform computing device 106, provided to the content source computing device 604, or included in a rendering authorization request transmitted to the spatial content authorization computing device 606.

The spatial content authorization request flow 600 may proceed to operation 614 where a rendering authorization request is transmitted with content metadata and spatial context. In various embodiments, at operation 614, the content source computing device 604 may transmit the rendering authorization request to the spatial content authorization computing device 606. The rendering authorization request may identify a digital content item and a physical asset or spatial region with which the digital content item is proposed to be visually associated, and may include structured metadata and context information usable to evaluate the proposed presentation.

In some embodiments, the rendering authorization request transmitted at operation 614 may correspond to the ad-match payload or/ad-match-request described in the provisional disclosure, but is described herein using broader technical terminology. For example, the rendering authorization request may include a request identifier, content identifier, content hash, content classification parameter, presentation-format parameter, requested presentation duration, requested presentation count, interactivity parameter, audio-output parameter, device-capability information, geolocation information, timestamp, ambient-condition information, or other contextual information. In some embodiments, the rendering authorization request may be generated by the content source computing device 604, by a rendering platform computing device 106, by the augmented reality user device 602, or by a combination of such devices.

The spatial content authorization request flow 600 may proceed to operation 616 where a machine-readable presentation policy is retrieved for a physical asset or spatial region. In various embodiments, at operation 616, the spatial content authorization computing device 606 may query the policy data store 608 using a spatial identifier included in or derived from the rendering authorization request. The machine-readable presentation policy may specify spatial presentation constraints and content presentation constraints for digital content associated with the physical asset or spatial region.

In some embodiments, the machine-readable presentation policy retrieved at operation 616 may correspond to an ARAdPolicy described in the provisional disclosure, but may be implemented more generally as a spatially associated machine-readable presentation policy. The policy may be associated with a building identifier, façade identifier, geofence identifier, parcel identifier, landmark identifier, surface identifier, spatial-anchor identifier, or other physical asset or spatial-region identifier. In some embodiments, the policy may include permitted content classifications, restricted content classifications, permitted presentation formats, time windows, viewing-angle constraints, viewing-distance constraints, interactivity constraints, audio-output constraints, privacy conditions, duration limits, presentation-count limits, policy version identifiers, policy hashes, or other constraints applicable to presentation of the digital content item.

The spatial content authorization request flow 600 may proceed to operation 618 where a policy version or policy hash is verified. In various embodiments, at operation 618, the spatial content authorization computing device 606 may verify integrity, currency, or authenticity of the machine-readable presentation policy using information stored by or accessible through the audit and ledger computing device 610. The verification may include comparing a policy version identifier, policy hash, signature, revocation indicator, or ledger reference associated with the retrieved policy against a stored or registered reference.

In some embodiments, operation 618 may correspond to the provisional disclosure's verification of an ARAdPolicy version and cryptographic hash against a blockchain. In the present disclosure, the audit and ledger computing device 610 may be implemented as an internal audit system, append-only log, permissioned ledger, distributed ledger, blockchain network, hash-anchoring service, or other verification system. Thus, a blockchain implementation is supported but not required. In some embodiments, verification at operation 618 may confirm that the machine-readable presentation policy has not been modified after registration, corresponds to a current or effective policy version, has not been revoked or superseded, and is associated with the physical asset or spatial region identified in the rendering authorization request.

The spatial content authorization request flow 600 may proceed along a first branch when policy constraints are satisfied. In various embodiments, the spatial content authorization computing device 606 may determine that the rendering authorization request satisfies the applicable spatial presentation constraints and content presentation constraints of the machine-readable presentation policy. This determination may be based on deterministic policy evaluation, semantic compatibility evaluation, content-hash verification, device-context evaluation, or combinations thereof.

At operation 620, a rendering authorization output may be transmitted when the policy constraints are satisfied. In various embodiments, the spatial content authorization computing device 606 may transmit the rendering authorization output to the content source computing device 604, a rendering platform computing device 106, the augmented reality user device 602, or another rendering system. The rendering authorization output may include an authorization indicator, one or more machine-readable rendering constraints, a permitted rendering region, an expiration time, a presentation-format condition, a presentation-duration condition, a presentation-count condition, a content hash, a policy version identifier, or a cryptographically signed rendering token.

In some embodiments, operation 620 may correspond to the provisional disclosure's approval response returned by the MatchEngine when an advertisement request satisfies the ARAdPolicy. In the present disclosure, the approval response is described more generally as a rendering authorization output. The rendering authorization output may define the technical conditions under which the digital content item may be presented, such as permitted spatial bounds, permitted presentation format, maximum presentation duration, maximum presentation count, device-context constraints, or token validation conditions. In some embodiments, the rendering authorization output may be locally validated by the augmented reality user device 602 before presentation occurs.

The spatial content authorization request flow 600 may include operation 622 where an audit record is stored. In various embodiments, at operation 622, the spatial content authorization computing device 606 may transmit audit information to the audit and ledger computing device 610 or may otherwise cause audit information to be stored. The audit record may include a request identifier, content identifier, content hash, policy identifier, policy version identifier, policy hash, spatial-region identifier, rendering authorization output hash, token identifier, timestamp, cryptographic signature, constraint satisfaction indicator, semantic compatibility score, revocation status, or distributed-ledger transaction reference.

In some embodiments, operation 622 may correspond to the provisional disclosure's optional logging of a match decision to a blockchain or internal audit system. In the present disclosure, the audit record may be stored using an audit database, append-only log, permissioned ledger, distributed ledger, blockchain network, or hash-anchoring service. In some embodiments, the audit record may omit raw gaze data, raw location data, raw camera images, or other raw sensor data while preserving sufficient information to verify that a particular rendering authorization output corresponded to a particular policy version, physical asset or spatial region, and digital content item.

The spatial content authorization request flow 600 may proceed along a second branch when a policy conflict is identified. In various embodiments, the spatial content authorization computing device 606 may determine that the rendering authorization request does not satisfy one or more spatial presentation constraints or content presentation constraints of the machine-readable presentation policy. A policy conflict may be identified when a requested presentation format is not permitted, a content classification is restricted, a viewing angle or viewing distance does not satisfy a threshold, a requested presentation time is outside an allowed time window, a content hash does not match an expected hash, an interactivity or audio-output condition is not satisfied, a token or policy version is invalid, or a semantic compatibility score fails to satisfy a threshold.

At operation 624, a denial output or modified rendering authorization output may be transmitted when a policy conflict is identified. In various embodiments, the spatial content authorization computing device 606 may transmit the denial output or modified rendering authorization output to the content source computing device 604, a rendering platform computing device 106, the augmented reality user device 602, or another rendering system. The denial output may indicate that presentation of the digital content item is not permitted in association with the physical asset or spatial region. The modified rendering authorization output may specify one or more modified presentation parameters under which presentation may be permitted.

In some embodiments, operation 624 may correspond to the provisional disclosure's rejection response or proposed alternative licensing terms, but is described herein using technical presentation-control terminology. For example, instead of identifying alternative licensing terms, the modified rendering authorization output may identify a modified presentation format, modified spatial region, modified presentation duration, modified viewing-angle condition, modified viewing-distance condition, modified interactivity condition, modified audio-output condition, modified content version, reduced visual size, relocated rendering region, delayed presentation time, substituted digital content item, or placeholder presentation. In some embodiments, the modified rendering authorization output may be generated by a constraint adjustment process or semantic compatibility process that determines one or more parameter adjustments capable of bringing the proposed presentation into compliance with the machine-readable presentation policy.

In some embodiments, the decision path illustrated in FIG. 6 may depend on the result of policy evaluation performed by the spatial content authorization computing device 606. Full matches may cause the system to transmit a rendering authorization output at operation 620 and optionally store an audit record at operation 622. Partial matches, inconclusive matches, or conflicts may cause the system to perform semantic compatibility evaluation, constraint adjustment, or both, before transmitting a denial output or modified rendering authorization output at operation 624. Although FIG. 6 illustrates the audit record being stored in connection with the satisfied-policy branch, audit records may additionally or alternatively be stored for denial outputs, modified rendering authorization outputs, policy conflicts, semantic compatibility evaluations, token validations, or other events.

The operations described above with reference to FIG. 6 are provided by way of example and not limitation. Although FIG. 6 illustrates a particular set of swim lanes and communication legs, one of ordinary skill in the art will recognize that additional, fewer, or alternative components and communications may be included without departing from the scope of the present disclosure. For example, a rendering platform computing device 106 may appear as an intermediary between the content source computing device 604 and the augmented reality user device 602, the augmented reality user device 602 may transmit the rendering authorization request directly to the spatial content authorization computing device 606, the policy data store 608 and audit and ledger computing device 610 may be implemented as integrated components of the spatial content authorization computing device 606, and semantic compatibility evaluation may be performed using one or more artificial intelligence service computing devices 112. Accordingly, the spatial content authorization request flow 600 may be modified, extended, distributed, or combined with other rendering authorization workflows while remaining within the scope of the present disclosure.

In some embodiments, and consistent with terminology used in the incorporated provisional disclosure, a machine-readable presentation policy may be implemented as a compact data structure referred to as an ARAdPolicy. The ARAdPolicy data model may encode policy attributes including, but not limited to, permissible content categories, blocked content categories, presentation formats, spatial boundaries, temporal conditions, visibility constraints, interactivity constraints, privacy rules, and licensing terms. Although some examples below use advertising-specific terminology, the same data structures and processing techniques may be used more generally to control presentation of digital content items relative to physical assets or spatial regions in augmented reality or extended reality computing environments.

In some embodiments, the ARAdPolicy structure may be serialized in a machine-readable format such as JavaScript Object Notation (JSON), Protocol Buffers, or another compact data representation. Each instance of an ARAdPolicy may be associated with a specific geospatial identifier, building reference, façade identifier, parcel identifier, surface identifier, or spatial-anchor identifier. In some embodiments, an ARAdPolicy may support hierarchical inheritance or composition to accommodate multi-tenant buildings, subdivided ownership, overlapping spatial regions, or multiple policy sources. In some embodiments, policy enforcement may involve matching incoming advertisement metadata or digital-content metadata against the constraints defined in the ARAdPolicy, with support for rule evaluation, semantic matching, score-based compliance thresholds, or combinations thereof. The following is an example ARAPolicy JSON:

| { | |
|---|---|
| “v”: 1, | |
| “pid”: “building-001”, | |
| “oid”: | |
| “owner-789”, | |
| “cat”: [“IAB1”, “IAB3-7”] , | |
| “blk”: [“IAB7-28”], | |
| “tm”: [ | |
| { | |
| “d”: [“Mon”, “Tue”, “Wed”, “Thu”, “Fri”], | |
| “s”: “08:00Z”, | |
| “e”: “20:00Z” | |
| } | |
| ] , | |
| “vis”: { | |
| “minD”: 5, | |
| “maxD”: 50, | |
| “ang”: [30, 150], | |
| “lux”: 100 | |
| } , | |
| “int”: { | |
| “clk”: true, | |
| “snd”: false, | |
| “cns”: true | |
| }, | |
| “fmt”: [“3D”, “hologram”, “video”], | |
| “geo”: { | |
| “type”: “polygon”, | |
| “coords”: [ | |
| [37.7749, −122.4194], | |
| [37.7750, −122.4185], | |
| [37.7740, −122.4180] | |
| ] | |
| }, | |
| “lic”: { | |
| “type”: “non-exclusive”, | |
| “rev”: 25, | |
| “dur”: 30, | |
| “imp”: 100000 | |
| } , | |
| “prs”: { | |
| “per”: false, | // allowPersonalizedAds |
| “dir”: false, | // allowDirectAddress |
| “cns”: true, | // requireConsent ForProfiling |
| “sns”: true | // sensitiveAudience |

```
  } ,
  “ts” : “2025-04-15T12:00:00Z”
}
```

In some embodiments, the fields of the ARAdPolicy object may be interpreted as follows. The field v may be an integer indicating a version number of the policy object. The field pid may be a string indicating a property identifier to which the policy applies. The field oid may be a string indicating an owner identifier or policy-authority identifier defining the policy. The field cat may be an array of strings identifying allowed content categories. The field blk may be an array of strings identifying blocked content categories. The field tm may be an array of objects defining time restrictions for display, including tm.d for days of the week, tm.s for a start time, and tm.e for an end time. The field vis may be an object defining visibility constraints, including vis.minD for a minimum viewing distance, vis.maxD for a maximum viewing distance, vis.ang for an allowed viewing-angle range, and vis.lux for a minimum ambient-light level. The field int may be an object defining interactivity rules, including int.clk indicating whether click or selection interaction is permitted, int.snd indicating whether audio output is permitted, and int.cns indicating whether user consent is required. The field fmt may be an array of strings identifying allowed presentation formats. The field geo may be an object defining a geofence area where the policy applies, including geo.type indicating a geofence type and geo.coords identifying coordinates defining the geofence. The field lic may be an object defining licensing terms, including lic.type, lic.rev, lic.dur, and lic.imp. The field prs may be an object defining personalized-presentation rules, including prs.dir, prs.cns, and prs.sns. The field ts may be a string indicating a timestamp of policy creation or update.

In some embodiments, content source computing devices, rendering platform computing devices, or augmented reality user devices may submit AdPermissionRequest payloads comprising structured data used to evaluate compliance with property-level or spatial-region-level policies. Each AdPermissionRequest may include metadata describing a proposed digital content item, such as a unique identifier, content category classification, and proposed rendering format. Additional contextual information may be included, such as geospatial coordinates of a target location, a timestamp indicating an intended time of display, device-specific attributes related to an augmented reality-capable device, and environmental factors such as ambient lighting conditions. In some embodiments, the payload may further specify proposed display parameters including desired duration of visibility, estimated number of presentations or impressions, and any interactive features associated with the digital content item. In cases where user consent is required based on jurisdictional privacy laws or stakeholder-defined conditions, the AdPermissionRequest may include a token or attestation serving as proof of obtained consent.

Submission of the AdPermissionRequest may be executed through an application programming interface endpoint, such as a POST request to a URI path, including/ad-match-request, or may be integrated directly into a software development kit embedded within augmented reality-capable client applications. In some embodiments, the request may trigger real-time policy evaluation workflows and automated response generation based on compliance results. The following is an example AdPermissionRequest JSON

```
{
  “requestId”: “req-001-abc”,
  “buildingId”: “building-001”,
  “adId”: “ad-xyz-987”,
  “category”: “IAB3-7”,
  “format”: “3D”,
  “timeOfRequest”: “2025-04-15T13:45:00Z”,
  “location”:
    “lat”: 37.775,
    “lng”: −122.419
  } ,
  “viewingAngle”: 45,
  “ambientLightLux”: 120,
  “isInteractive”: true,
  “hasSound”: false,
  “userConsentRequired”: true,
  “impressionsPlanned”: 10000,
  “durationSeconds”: 30
}
```

In some embodiments, the fields of the AdPermissionRequest object may be interpreted as follows. The field request Id may be a string identifying a unique request. The field buildingId may be a string identifying a building or other physical asset where the digital content item is intended to be shown. The field adId may be a string identifying or hashing the advertisement or digital content item. The field category may be a string identifying a content category. The field format may be a string identifying a media or presentation format, such as 3D, video, image, or hologram. The field timeOfRequest may be a datetime value indicating when the digital content item is intended to be displayed. The field location may be an object identifying a geographic location of a user device or display device, including location.lat and location. Ing. The field viewingAngle may be a number indicating an angle between a user gaze or device viewing direction and a building or other physical asset. The field ambientLightLux may be a number indicating a current ambient-light level. The field is Interactive may be a Boolean indicating whether the digital content item is interactive. The field hasSound may be a Boolean indicating whether the digital content item includes audio output. The field userConsentRequired may be a Boolean indicating whether the requested presentation requires explicit user consent based on interactivity, personalization, regional law, or policy conditions. The field impressions Planned may be an integer indicating a number of planned presentations or impressions. The field durationSeconds may be an integer indicating a proposed duration of display in seconds.

In some embodiments, a MatchEngine, spatial content authorization engine, or other policy evaluation engine may evaluate each AdPermissionRequest against a corresponding ARAdPolicy using a two-stage processing pipeline. A first stage may involve deterministic rule evaluation, in which explicit policy constraints are validated against attributes contained within the request payload. This evaluation may include confirming that the declared content category matches one of the permitted categories defined in the policy, verifying that the proposed display format is among supported formats, and checking that environmental conditions and temporal parameters, such as time of day and ambient light levels, fall within allowable ranges. Further rule checks may include validating that proposed usage attributes, such as duration and number of presentations or impressions, do not exceed thresholds or violate constraints defined in the ARAdPolicy. The system may also confirm that any required user consent has been included and that interactive components conform to interactivity permissions specified by the policy.

If all constraints are satisfied during deterministic evaluation, the digital content item may be designated as compliant and approved for rendering at the specified physical location or spatial region. If the deterministic rule evaluation fails to establish compliance or yields an inconclusive result, such as when metadata is imprecise, policy language lacks specificity, or overlapping ARAdPolicy records introduce conflicting constraints, the MatchEngine or spatial content authorization engine may invoke one or more artificial intelligence modules to perform adaptive evaluation of the request. These modules may support intelligent policy interpretation and content adaptation in cases where rigid rule-based matching is insufficient.

In some embodiments, a component referred to as a SemanticMatcher may be configured to perform semantic comparison between advertisement metadata or digital-content metadata and relevant policy constraints. This process may involve transforming both descriptive attributes of the digital content item and the policy definitions into numerical embeddings situated in a shared vector space. These embeddings may capture semantic relationships, allowing conceptual alignment to be evaluated even in the absence of explicit categorical matches. The SemanticMatcher may apply similarity metrics, such as cosine similarity, to assess a degree of alignment between the intended meaning of the digital content item and the expressed policy intent. In some embodiments, if the computed similarity score exceeds a configurable threshold, such as 0.75, the system may classify the request as conditionally compliant. The follow is an example SemanticMatcher Input:

| | |
|---|---|
| { | |
| | “adText”: “Explore modern condos today!”, |
| | “policyTags”: [“real estate”, “weekday-only”] |
| } | |

Example Output: Cosine similarity score (0-1). Threshold: >0.75 indicates acceptable match.

In some embodiments, semantic alignment may be identified using transformer-based models trained to generate contextualized embeddings of input text. Supported models may include Bidirectional Encoder Representations from Transformers (BERT), Robustly Optimized BERT Pretraining Approach (ROBERTa), SentenceTransformer, or other embedding models capable of producing comparable semantic vector representations. In some embodiments, semantic compatibility evaluation may further include image classification, multimodal embedding, knowledge graph traversal, ontology mapping, or content-safety classification.

In some embodiments, a component referred to as a ConstraintSolver may be employed to evaluate requests in relation to applicable ARAdPolicy constraints and, upon identifying violations, compute parameter modifications that would bring the request into compliance with minimal deviation from original request parameters. The ConstraintSolver may apply optimization techniques to adjust specific parameters of the request, such as shortening a proposed display duration, reducing an allowed number of presentations or impressions, or altering a content format to a more restricted or lower-impact version, such as from a three-dimensional model to a static image overlay. The component may operate by parsing policy-defined limits and applying constraint satisfaction or bounded optimization algorithms to derive a revised set of display parameters that fall within permitted ranges. The following is an example ConstraintSolver Input:

| | |
|---|---|
| { | |
| | “requested”: { “duration”: 60, “impressions”: 10000 }, |
| | “policy”: { “maxDuration”: 30, “max Impressions”: 5000 } |
| } | |

An example ConstraintSolver Output may be provided such as the following example:
{“duration”: 30, “impressions”: 5000}

In some embodiments, an optional component referred to as a PolicyNegotiator may be configured to generate alternative configurations that address minor conflicts between a request and an applicable ARAdPolicy, while remaining consistent with policy intent. The PolicyNegotiator may be invoked when a request nearly satisfies relevant policy conditions but fails on one or more constraints designated as adjustable or negotiable. Such constraints may include, for example, exceeding a defined presentation-count threshold, requesting a non-standard display format, or requesting a parameter value below a policy-defined baseline. Instead of issuing a rejection, the PolicyNegotiator may construct an alternative configuration that includes modifications such as substituting a simplified content format, reducing display duration, reducing presentation count, or proposing adjusted terms. The following is an example PolicyNegotiator Output:

```
{
  “proposedLicense”: {
    “format”: “image”,
    “durationSeconds”: 10,
    “revenueSharePercent”: 30
  }
}
```

In some embodiments, the PolicyNegotiator component may be implemented using decision trees, rule-based optimization engines, generative modeling approaches, or combinations thereof. Generative models may include large language models that may be fine-tuned on datasets comprising historical policy-response scenarios to support context-aware synthesis of alternative configurations. In rule-based or decision-tree implementations, predefined logic paths may be followed to identify minimally invasive parameter adjustments. In either case, the output of the PolicyNegotiator may be formatted as a candidate configuration that can be presented for approval, integrated into automated negotiation workflows, or used to trigger additional validation steps.

In some embodiments, the policy evaluation process may be implemented using pseudocode corresponding to an evaluate_ad_permission function. The following pseudocode uses field names and terminology from the incorporated provisional disclosure. In the broader terminology used elsewhere herein, adRequest may correspond to a rendering authorization request, buildingId may correspond to a physical asset identifier or spatial-region identifier, policy may correspond to a machine-readable presentation policy, and approval or denial outputs may correspond to rendering authorization outputs. The following is pseudocode example implementation: evaluate_ad_permission (adRequest)

```
function evaluate_ad_permission(adRequest):
  policy = fetch_policy(adRequest.buildingId)
  if not policy:
    return deny (reason=“POLICY_NOT_FOUND”)
  # Step 1: Validate Category and Format
  if adRequest.category not in policy.cat or
adRequest.category in policy.blk:
    return deny (reason=“CATEGORY_NOT_ALLOWED”)
  if adRequest. format not in policy.fmt:
    return deny (reason=“FORMAT_NOT_ALLOWED”)
  # Step 2: Check Time and Environmental Constraints
  if not is_within_time_window (adRequest.timeOfRequest,
policy.tm):
    return deny (reason=“TIME_RESTRICTION_VIOLATION”)
  if not satisfies_visibility (adRequest, policy.vis):
    return deny (reason=“VISIBILITY_CONSTRAINT_FAIL”)
  # Step 3: Interactivity and Consent
  if adRequest.isInteractive and not policy.int.clk:
    return deny (reason=“INTERACTIVITY_NOT_ALLOWED”)
  if adRequest.hasSound and not policy.int.snd:
    return deny (reason=“AUDIO_NOT_ALLOWED” )
  if policy.prs.cns and not adRequest.userConsentRequired:
    return deny (reason=“CONSENT_REQUIRED” )
  # Step 4: Check Licensing Limits
  if adRequest.impressionsPlanned > policy.lic.imp:
    return deny (reason=“IMPRESSIONS_LIMIT_EXCEEDED”)
  if adRequest.durationSeconds > policy.lic.dur * 86400:
    return deny (reason=“DURATION_EXCEEDED” )
  # Step 5: (Optional) AI Assisted Policy Negotiation
  if is_partial_match (adRequest, policy):
    return ai_assisted_fallback (adRequest, policy)
  return approve (reason=“FULL_MATCH”, license=policy.lic)
```

As shown above, in some embodiments, an evaluation function may determine whether a submitted request complies with a digital rights policy associated with a specified physical property or spatial region. The evaluation process may begin by retrieving the applicable policy based on a building identifier or other spatial identifier included in the request. If no policy is found for the specified location, the request may be denied due to the absence of a governing policy. Once a policy is located, the system may proceed through deterministic validation steps including category validation, format validation, time-window validation, visibility validation, interactivity validation, consent validation, presentation-count validation, and duration validation. If the request fails to fully comply but exhibits characteristics indicating a close or partial match with the policy constraints, an AI-assisted fallback mechanism may be invoked. If all validation steps are successfully passed without violations, the request may be approved and returned with applicable policy-derived parameters.

In some embodiments, tamper resistance and data integrity for permissions and policy evaluations may be implemented through blockchain anchoring or another audit and ledger mechanism. Each approved ARAdPolicy or AdPermissionRequest evaluation result may be serialized as a compact payload, encoded in Base64 format or cryptographically hashed, and then written to a blockchain ledger such as Hyperledger Fabric, Ethereum, Solana, or another permissioned or public ledger. The storage key used for each entry may be constructed as a deterministic composite of the property identifier, such as buildingId, a policy version identifier, and a unique requestId corresponding to the specific evaluation event. This composite key structure may support immutable storage and traceable historical records, allowing past approvals or denials to be independently verified or audited over time.

In some embodiments, to improve storage efficiency of blockchain entries, particularly in permissioned-ledger environments, field names within serialized ARAdPolicy objects may be intentionally abbreviated. For example, the property identifier may be represented as pid, the list of allowed content categories may be represented as cat, visibility constraints may be represented as vis, privacy rules may be represented as prs, and licensing parameters may be represented as lic. This compact naming convention may reduce the overall byte size of serialized entries, which may reduce ledger storage costs, improve transaction throughput, reduce mobile bandwidth usage, and reduce API response latency.

In some embodiments, the complete policy or permission object may be serialized as a JSON string. The serialized string may either be base64-encoded and stored directly as a value in a blockchain state database or processed through a cryptographic hash function such as Secure Hash Algorithm 256 (SHA-256), with only the resulting digest stored on-chain. In the latter case, the full serialized object may be stored off-chain in a trusted repository, such as the InterPlanetary File System (IPFS), an Amazon S3 bucket, a dedicated policy registry, or another trusted storage system. The blockchain key format used for storing entries may follow a standardized structure such as policy::<pid>::v<version>, where pid corresponds to the property identifier and version corresponds to a specific version of the policy in use.

In some embodiments, write operations to a blockchain or permissioned ledger may require authenticated identities managed by a membership service provider or another identity-management component. Each identity may correspond to a known organization or role within an ecosystem, such as a property owner, rights management service, platform administrator, policy configuration authority, or delegated signer. In some embodiments, only a designated policy owner identified by an owner identifier oid, or an explicitly delegated signing authority, may be permitted to create, modify, or revoke ARAdPolicy entries. Unauthorized actors attempting to submit or overwrite policy data may be rejected based on identity validation rules enforced by smart contract logic, chaincode, access-control logic, or another policy-enforcement mechanism.

In some embodiments, to ensure the integrity and trustworthiness of evaluation outcomes, the matchmaking engine or spatial content authorization engine may digitally sign each match result using a private cryptographic key associated with the platform. This digital signature may be included in a response returned to a requesting device or may be written to a ledger alongside decision metadata. These signatures may allow a verifier with access to the platform's public key to validate that the decision was generated by an authorized engine instance and that the result has not been modified since issuance. This mechanism may support non-repudiation, auditability, and dispute resolution by providing a cryptographically verifiable record of the decision logic applied to each request.

In some embodiments, privacy-preserving mechanisms and consent enforcement protocols may be incorporated to reduce exposure of user data in scenarios involving personalization or context-aware rendering. When targeting or context-aware rendering is conditioned on user-specific attributes, the platform may require explicit opt-in consent through client-side workflows integrated into augmented reality applications or operating systems. These workflows may capture consent using structured formats such as JSON Web Tokens, verifiable credentials, or another consent-attestation format. In some embodiments, no personally identifiable information is stored on-chain. Evaluation processes may be performed using anonymized or pseudonymized metadata, including environmental inputs such as ambient light levels, geospatial coordinates, or device capabilities that do not directly identify an end user.

In some embodiments, sensitive information included in a payload, such as pricing information, exclusive-use terms, or high-value property identifiers, may be encrypted using symmetric encryption algorithms such as Advanced Encryption Standard in Galois/Counter Mode (AES-GCM). A corresponding decryption key may be securely exchanged out-of-band or via a trusted key management system, enabling policy validation and matching to be performed off-chain, within a secure enclave, or within another trusted execution environment.

In some embodiments, multiple layers of fraud mitigation and abuse detection may be implemented around a request endpoint such as/ad-match-request. These protections may include rate limiting based on source IP address or authenticated organization identifier, throttling of excessive request volumes, HMAC-authenticated tokens issued to verified entities, behavioral analytics for detecting anomalous access patterns, detection of rapid-fire requests, detection of location spoofing, or detection of inconsistent metadata signatures. Detected anomalies may trigger automated enforcement actions, such as temporary suspension, stricter verification challenges, or escalation to a manual review workflow.

Table 1 illustrates an example threat model-STRIDE-based:

TABLE 1

| | |
|---|---|
| Spoofing | Fabric MSP-based identities; JWT tokens |
| Tampering | Signatures + hashes on policies and matches |
| Repudiation | Immutable logs on Hyperledger Fabric |
| Information Disclosure | No PII stored on-chain; anonymized context only |
| Denial Of Service | API throttling, adaptive rate limiting |
| Elevation Of Privilege | Chaincode enforces signer-to-owner binding |

In some embodiments, the system may incorporate multimodal artificial intelligence models to perform inspection and classification of digital content assets. These models may be configured to analyze visual inputs, such as images, video frames, or three-dimensional renders, alongside associated textual metadata to detect potential category misalignment, policy violations, or content deemed inappropriate based on contextual factors. Multimodal models such as CLIP or BLIP may be employed to embed both a visual asset and accompanying text into a shared representation space, allowing semantic comparison between content and policy definitions or content safety guidelines. This process may allow the system to flag instances where a digital content item is incorrectly categorized or where visual content exhibits features that violate safety or policy guidelines.

In some embodiments, the system may support gaze-aware rendering logic that leverages input from user-facing sensors, such as eye-tracking hardware embedded in augmented reality headsets or glasses. In such embodiments, a digital content item may be rendered into the user's view only if the user is actively looking at the designated physical asset or spatial region to which the digital content item is spatially anchored. This conditional rendering approach may be based on the direction and fixation duration of the user's gaze vector relative to spatial coordinates of a target property, façade, surface, or spatial anchor. If gaze data indicates a lack of engagement or attention, the rendering engine may defer or cancel display, thereby reducing unnecessary processing and preserving contextual relevance.

In some embodiments, the system may implement a performance-based feedback mechanism that refines policy matching and content evaluation logic. The feedback loop may be driven by usage data, including click-through rate, user interaction dwell time, rejection frequency, user interventions, manual overrides, or other performance signals. These signals may be collected and aggregated to train or fine-tune machine learning models used in semantic matching, constraint evaluation, or content safety prediction. Over time, this adaptive feedback process may improve the system's ability to recommend compliant and contextually effective presentation configurations, while reducing false positives and false negatives in automated approvals or denials.

In some embodiments, the system may support multiple deployment configurations. One deployment option may involve a cloud-hosted microservice that exposes application programming interfaces consumed by augmented reality platforms, rendering networks, or software development kits embedded in client-side applications. In this configuration, the system may function as a centralized service that receives permission requests, evaluates them against relevant policies, and returns approval decisions, adjusted configurations, or rejection justifications in real time. Alternatively, or additionally, the system may be deployed as an edge inference module designed for execution on-device or near a user environment to support low-latency, offline policy evaluation. This edge-deployable version may include a compact policy cache, a lightweight rules engine, and one or more precompiled or quantized artificial intelligence models capable of performing semantic matching or constraint resolution without requiring continuous connectivity to a central server. A third deployment model may include the system functioning as a compliance oracle within a blockchain-based protocol. In this configuration, the system may serve as a trusted off-chain computation service that validates whether a proposed transaction or rendering event conforms to digital rights policies registered on-chain and may write an outcome, signed attestation, or hash of a permission response back to the blockchain.

In some embodiments, the system may support a decentralized variation in which matching is performed entirely on the client side within an augmented reality user device. In this architecture, a matchmaking engine or policy enforcement engine may be embedded directly into the augmented reality-capable device and may execute real-time evaluations based on locally available data. Policy information may be stored in a local cache, periodically synchronized with a centralized repository, or retrieved on demand via lightweight ledger or smart contract queries. The evaluation logic may be packaged as a lightweight inference module or rule engine capable of interpreting ARAdPolicy objects and applying them to requests generated in real time as the user interacts with physical environments.

In some embodiments, client-side execution may preserve privacy because user-specific contextual data, including gaze vectors, positional coordinates, and consent signals, may remain on the device without requiring transmission to external servers. Client-side execution may also reduce latency by eliminating round-trip network delays, enabling near-instantaneous rendering decisions. In some embodiments, routine policy evaluations may be handled locally, while escalations such as ambiguous matches, disputes, or high-value interactions may be deferred to a cloud-based adjudication service or compliance oracle that logs final decisions to a ledger.

In some embodiments, a public blockchain network such as Ethereum, Solana, Polygon, or another public ledger may be used instead of or in addition to a permissioned ledger. This public anchoring approach may involve writing cryptographic hashes of ARAdPolicy objects, AdPermissionRequest decisions, signed payloads, or other permission artifacts to a globally accessible blockchain, allowing third parties to independently verify the existence, integrity, and issuance sequence of these records without reliance on a centralized authority. In some embodiments, high-value or disputed events may be selectively anchored to a public chain, while routine operations are logged on a permissioned ledger or retained off-chain with cryptographic proofs. Decentralized storage solutions such as IPFS may be used with public blockchain hashes to store complete payloads off-chain while maintaining a verifiable link.

In some embodiments, direct policy storage may be replaced or supplemented with tokenized certificates representing rights or permissions. These certificates may take the form of non-fungible tokens, verifiable credentials, or other blockchain-based assets that encode the specific conditions under which a digital content item may be rendered. Each token may represent a discrete and time-bound entitlement, such as the right to display a particular category of content on a defined property during specified hours or under certain environmental conditions. Token metadata may include constraints such as geographic bounding boxes, maximum presentation counts, interactive modality permissions, and cryptographic links to externally stored ARAdPolicy documents or hashes anchored to a public blockchain.

In some embodiments, the system may support a variation in which the matching process is performed exclusively by an artificial intelligence engine operating in a fully autonomous manner without relying on rule-based logic or deterministic evaluation paths. This AI-only matching architecture may leverage a deep learning model trained on historical match decisions, user engagement metrics, rejection patterns, policy definitions, stakeholder feedback, or combinations thereof. The model may learn to infer policy alignment by identifying latent patterns and contextual correlations between request attributes and prior approval outcomes. To mitigate risks associated with opaque decision-making, the system may incorporate a human-in-the-loop oversight mechanism, flag low-confidence matches or ambiguous cases for review, or provide an explainability layer using attention visualization, feature attribution, contrastive example generation, or similar techniques.

In some embodiments, the system may incorporate a geospatial rights inference mechanism as an alternative to requiring manual configuration of policies. This variation may allow the platform to automatically generate default ARAdPolicy profiles or machine-readable presentation policies for physical locations based on external geospatial datasets. Inferred policies may be derived from zoning classifications, land-use records, municipal open data, census demographics, pedestrian traffic patterns, historical content activity, geographic information systems, property databases, urban planning records, or combinations thereof. Inferred policies may include baseline restrictions based on location-specific risk factors, such as proximity to schools, hospitals, religious institutions, protected landmarks, or other sensitive locations. In some embodiments, inferred policies may be cryptographically marked as inferred policies to distinguish them from stakeholder-signed configurations.

In some embodiments, the system may implement offline verification through signed tokens that encapsulate the outcome of policy matching evaluations. Once a request has been evaluated centrally or at the edge, the resulting decision may be issued in the form of a cryptographically signed token, such as a JSON Web Token or similarly structured verifiable artifact. These tokens may contain metadata associated with the decision, including an identifier of the digital content item, permitted rendering parameters, duration, presentation count, content format, policy version, and contextual constraints that were satisfied at the time of issuance. The token may be digitally signed by a matchmaking engine or spatial content authorization engine using a platform private key, allowing any verifying party, such as a publisher application, rendering software development kit, or augmented reality-capable device, to confirm authenticity using the corresponding public key.

In some embodiments, signed tokens may support offline-first use cases where real-time validation is not feasible due to latency, network unavailability, or system architecture constraints. To address revocation and lifecycle concerns, the system may enforce strict token expiration policies, maintain a revocation registry or token blacklist accessible via lightweight cacheable API calls, distribute periodic broadcast updates, or bind tokens to contextual conditions such as geofences, time windows, device types, façade identifiers, creative hashes, maximum presentation counts, gaze-dwell thresholds, or expiration epochs. In some embodiments, a rendering device may validate the token locally by executing a signature check and a hash comparison, thereby transforming a latency-bound network transaction into an on-device cryptographic operation.

In some embodiments, a client-side policy matching module may maintain a multilayer policy cache in which each record is bound to a geospatial parcel identifier and includes cryptographically signed fields for presentation caps, gaze-dwell thresholds, creative categories, and consent or policy-authority information. A lightweight inference module running on a headset may project a six-degree-of-freedom pose into a scene graph, hash a resulting façade identifier, and retrieve matching policy or license records without revealing raw location data to remote services. In some embodiments, the local cache may be encoded as a Merkle tree whose leaves correspond to parcel-level policies signed by distinct stakeholders. Delta messages carrying modified tree branches may update selected entries without replacing the entire dataset, thereby reducing cold-start latency and bandwidth usage.

In some embodiments, policy fragments may carry independent signatures from property owners, content sources, municipal regulators, or other authorities. The augmented reality user device may assemble such fragments into a composite license or composite presentation policy at render time by executing an intersection routine over the constraints. Because each signer's terms remain separately verifiable, a platform may prove ex-post compliance without exposing user-level telemetry, and the user device may discard any fragment whose signature fails. In some embodiments, this approach may contain supply-chain attacks and allow rule sets signed by distinct counterparties to be merged without recompiling a static ruleset.

In some embodiments, the system may generate a geospatial rights map or inferred policy layer by traversing parcel databases, ingesting zoning shapefiles, traffic sensor feeds, demographic rasters, or other geospatial datasets, and applying a classifier that outputs, for each lot or spatial region, a machine-readable license or policy encoding baseline limits such as maximum luminance, dwell-time caps, and category exclusions. By precomputing a rights map covering a geography rather than reacting only to individually configured requests, the system may provide immediate policy coverage for programmatic augmented reality exchanges or rendering platforms. In some embodiments, inferred policy blobs may be cryptographically signed, cached on edge devices, and validated with a single signature operation at render time.

In some embodiments, terminology used in the provisional disclosure may map to the broader terminology used elsewhere in the present disclosure. For example, an ARAdPolicy may correspond to a machine-readable presentation policy; an AdPermissionRequest may correspond to a rendering authorization request; a MatchEngine may correspond to a spatial content authorization engine or spatial content authorization computing device; a PolicyStore may correspond to a policy data store; a blockchain may correspond to an audit and ledger computing device; an advertiser may correspond to a content source computing device; an advertisement may correspond to a digital content item; licensing terms may correspond to machine-readable rendering constraints or modified presentation parameters; and a rejection or approval response may correspond to a denial output, rendering authorization output, modified rendering authorization output, or cryptographically signed rendering token. This terminology mapping is provided to clarify that the technical mechanisms disclosed herein are not limited to commercial advertising implementations and may be applied to policy-controlled presentation of digital content in augmented reality or extended reality computing environments.

These techniques may be used both with wearable stereoscopic displays, like augmented reality or virtual reality headsets, and with non-stereoscopic two-dimensional displays, like tablet computers, laptop computers, automobile windshield displays, mobile phones, and the like. Further, the techniques herein may be implemented with the approaches described in U.S. Provisional Patent Application 63/790,533, filed Apr. 17, 2025, titled DYNAMIC GEOSPATIAL DNS WITH DRM CAPABILITIES; U.S. Provisional Patent Application No. 63/790,536, filed Apr. 17, 2025, titled AUTOMATED ADVERTISING INSURANCE AND RIGHTS MANAGEMENT FOR DIGITAL REAL ESTATE ADVERTISING; U.S. Provisional Patent Application No. 63/878,865, filed Sep. 9, 2025, titled BIOMETRIC-UNLOCKED PERSONAL DIGITAL RIGHTS FRAMEWORK; U.S. Provisional Patent Application No. 63/888,268, filed Sep. 16, 2025, titled SEGMENT-LEVEL CRYPTOGRAPHIC VERIFICATION OF ADAPTIVE STREAMING CONTENT; U.S. Provisional Patent Application No. 63/924,259, filed Nov. 24, 2025, titled ADAPTIVE COLLECTION PROTOCOL FOR CONTEXT-AWARE, PRIVACY-PRESERVING AR TELEMETRY AND DIGITAL RIGHTS ENFORCEMENT; U.S. Provisional Patent Application No. 63/990,881, filed Feb. 25, 2026, titled SYSTEM AND METHOD FOR DISTRIBUTED TRUST-STATE MANAGEMENT AND DETERMINISTIC CRYPTOGRAPHIC VERIFICATION; and U.S. Provisional Patent Application No. 64/041,522, filed Apr. 16, 2026, titled SYSTEMS AND METHODS FOR REGISTRATION, ENFORCEMENT, AND MONETIZATION OF HUMAN-CENTRIC DIGITAL RIGHTS; U.S. patent application Ser. No. 19/651,373, filed Apr. 17, 2026, titled DYNAMIC GEOSPATIAL DNS WITH DRM CAPABILITIES; U.S. patent application Ser. No. 19/651,367, filed Apr. 17, 2026, titled AUTOMATED ADVERTISING INSURANCE AND RIGHTS MANAGEMENT FOR DIGITAL REAL ESTATE ADVERTISING, each filed by the same Applicant, the contents of which are hereby incorporated by reference.

Thus, systems and methods of the present disclosure provide spatial content authorization for controlling presentation of digital content relative to physical assets and spatial regions in augmented reality or extended reality computing environments. By receiving rendering authorization requests, retrieving machine-readable presentation policies associated with physical assets or spatial regions, evaluating spatial presentation constraints and content presentation constraints, generating rendering authorization outputs, issuing cryptographically verifiable rendering tokens, and enabling device-side enforcement of machine-readable rendering constraints, the disclosed systems may provide consistent and auditable control over when and how digital content is presented in relation to physical-world contexts. The disclosed techniques may improve operation of augmented reality computing systems by reducing latency associated with presentation authorization, reducing repeated network communication during rendering, enabling local verification of signed tokens or signed policy fragments, preserving raw device-context data on an augmented reality user device, and improving traceability, reproducibility, and integrity of rendering authorization decisions across distributed computing environments.

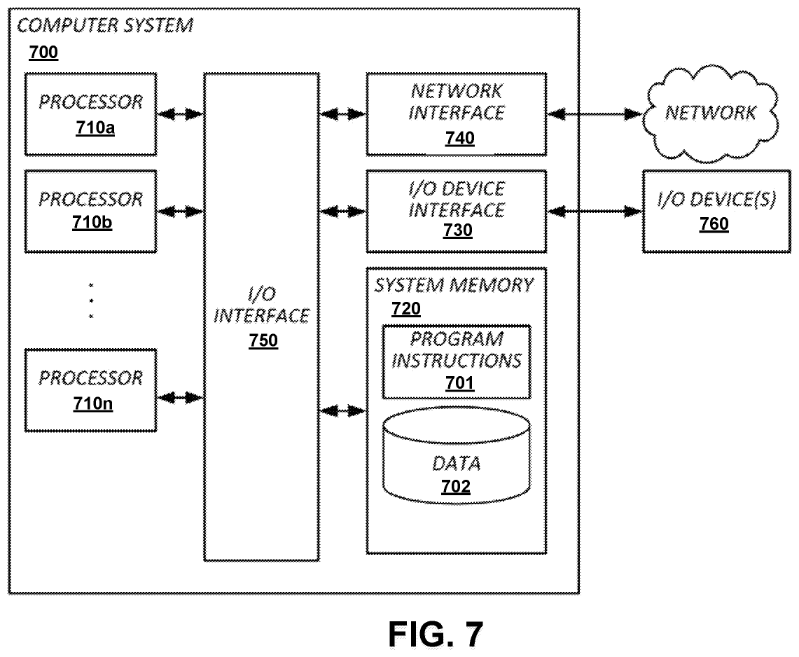

FIG. 7 is a diagram that illustrates an exemplary computing system 700 by which the components above may be built. A single computing device is shown, but some embodiments of a computer system may include multiple computing devices that communicate over a network, for instance in the course of collectively executing various parts of a distributed application. Various portions of systems and methods described herein, may include or be executed on one or more computer systems similar to computing system 700. Further, processes and modules described herein may be executed by one or more processing systems similar to that of computing system 700.

Computing system 700 may include one or more processors (e.g., processors 710a-710n) coupled to system memory 720, an input/output I/O device interface 730, and a network interface 740 via an input/output (I/O) interface 750. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 700. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 720). Computing system 700 may be a uni-processor system including one processor (e.g., processor 710a), or a multi-processor system including any number of suitable processors (e.g., 710a-710n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 700 may include a plurality of computing devices (e.g., distributed computer systems) to implement various processing functions.

I/O device interface 730 may provide an interface for connection of one or more I/O devices 760 to computer system 700. I/O devices may include devices that receive input (e.g., from a user) or output information (e.g., to a user). I/O devices 760 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 760 may be connected to computer system 700 through a wired or wireless connection. I/O devices 760 may be connected to computer system 700 from a remote location. I/O devices 760 located on remote computer system, for example, may be connected to computer system 700 via a network and network interface 740.

Network interface 740 may include a network adapter that provides for connection of computer system 700 to a network. Network interface may 740 may facilitate data exchange between computer system 700 and other devices connected to the network. Network interface 740 may support wired or wireless communication. The network may include an electronic communication network, such as the Internet, a local area network (LAN), a wide area network (WAN), a cellular communications network, or the like.

System memory 720 may be configured to store program instructions 701 or data 702. Program instructions 701 may be executable by a processor (e.g., one or more of processors 710a-710n) to implement one or more embodiments of the present techniques. Instructions 701 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 720 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 720 may include a non-transitory computer readable storage medium that may have program instructions stored thereon that are executable by a computer processor (e.g., one or more of processors 710a-710n) to cause the subject matter and the functional operations described herein. A memory (e.g., system memory 720) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 750 may be configured to coordinate I/O traffic between processors 710a-710n, system memory 720, network interface 740, I/O devices 760, and/or other peripheral devices. I/O interface 750 may perform protocol, timing, or other data transformations to convert data signals from one component (e.g., system memory 720) into a format suitable for use by another component (e.g., processors 710a-710n). I/O interface 750 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 700 or multiple computer systems 700 configured to host different portions or instances of embodiments. Multiple computer systems 700 may provide for parallel or sequential processing/execution of one or more portions of the techniques described herein.

Those skilled in the art will appreciate that computer system 700 is merely illustrative and is not intended to limit the scope of the techniques described herein. Computer system 700 may include any combination of devices or software that may perform or otherwise provide for the performance of the techniques described herein. For example, computer system 700 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 700 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 700 may be transmitted to computer system 700 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:
Clause 1. A computer-implemented method, comprising: receiving, by one or more processors of a spatial content authorization system, a rendering authorization request for presenting a digital content item in an augmented reality environment, the rendering authorization request identifying the digital content item and a physical asset or spatial region with which the digital content item is proposed to be visually associated; retrieving, by the one or more processors, a machine-readable presentation policy associated with the physical asset or spatial region, the machine-readable presentation policy specifying spatial presentation constraints and content presentation constraints for augmented reality content associated with the physical asset or spatial region; extracting, by the one or more processors and from the rendering authorization request, request parameters including at least a content classification parameter, a spatial-context parameter, and a presentation-format parameter; comparing, by the one or more processors, the request parameters with the machine-readable presentation policy to determine whether the rendering authorization request satisfies the spatial presentation constraints and the content presentation constraints; generating, by the one or more processors and based on the comparing, a rendering authorization output that specifies whether the digital content item is permitted to be presented in association with the physical asset or spatial region; and transmitting, by the one or more processors, the rendering authorization output to an augmented reality rendering system configured to control presentation of the digital content item in the augmented reality environment.
Clause 2. The computer-implemented method of clause 1, wherein the machine-readable presentation policy includes one or more of a geofence identifier, a façade identifier, a parcel identifier, a viewing-angle constraint, a viewing-distance constraint, a time-window constraint, a permitted presentation-format constraint, an interactivity constraint, an audio-output constraint, or a privacy-condition constraint.
Clause 3. The computer-implemented method of clause 1, wherein extracting the request parameters includes determining, from the rendering authorization request, at least one of a location of an augmented reality user device, a pose of the augmented reality user device, a gaze direction, a field-of-view parameter, an ambient condition, a requested display duration, or a requested impression-count parameter.
Clause 4. The computer-implemented method of clause 1, further comprising: when the comparing indicates that a deterministic constraint of the machine-readable presentation policy is not satisfied, generating a modified rendering authorization output that specifies at least one modified presentation parameter under which the digital content item is permitted to be presented.
Clause 5. The computer-implemented method of clause 4, wherein the at least one modified presentation parameter includes a modified spatial region, a modified presentation format, a modified presentation duration, a modified viewing-angle condition, a modified interactivity condition, or a modified audio-output condition.
Clause 6. The computer-implemented method of clause 1, further comprising: generating a semantic representation of at least one of the digital content item or metadata associated with the digital content item, comparing the semantic representation with a semantic representation of at least a portion of the machine-readable presentation policy, and determining semantic compatibility between the digital content item and the machine-readable presentation policy based on the comparison.
Clause 7. The computer-implemented method of clause 6, wherein determining the semantic compatibility includes computing a similarity score between the semantic representation of the digital content item and the semantic representation of the portion of the machine-readable presentation policy, and determining that the rendering authorization request satisfies a policy condition when the similarity score satisfies a threshold.
Clause 8. The computer-implemented method of clause 1, further comprising: generating a cryptographically signed rendering token that encodes at least a portion of the rendering authorization output and one or more rendering constraints applicable to presentation of the digital content item.
Clause 9. The computer-implemented method of clause 8, wherein the cryptographically signed rendering token includes at least one of an identifier of the digital content item, an identifier of the physical asset or spatial region, a version identifier of the machine-readable presentation policy, a permitted rendering region, an expiration time, a presentation-format condition, a content hash, or a signature generated using a private key associated with the spatial content authorization system.
Clause 10. The computer-implemented method of clause 1, further comprising: storing an audit record associated with the rendering authorization output, wherein the audit record includes at least one of a hash of the machine-readable presentation policy, a policy version identifier, a request identifier, a content identifier, a timestamp, a cryptographic signature, or a distributed-ledger transaction reference.
Clause 11. A computer-implemented method comprising: obtaining, by one or more processors of an augmented reality user device, sensor data associated with a physical environment of the augmented reality user device; determining, by the one or more processors and based on the sensor data, a physical asset or spatial region within a field of view of the augmented reality user device; accessing, by the one or more processors, authorization data associated with a digital content item proposed for presentation in association with the physical asset or spatial region; determining, by the one or more processors and based on the authorization data, whether presentation of the digital content item in association with the physical asset or spatial region satisfies one or more machine-readable rendering constraints; and controlling, by the one or more processors and based on the determining, presentation of the digital content item by causing the augmented reality user device to apply a presentation control operation to the digital content item relative to the physical asset or spatial region.
Clause 12. The computer-implemented method of clause 11, wherein the sensor data includes one or more of location data, inertial measurement data, camera data, depth-sensing data, pose data, gaze data, field of view data, ambient-light data, or orientation data.
Clause 13. The computer-implemented method of clause 11, wherein determining the physical asset or spatial region includes mapping a pose or location of the augmented reality user device to at least one of a geofence, parcel, façade, surface, landmark, building, or spatial anchor.
Clause 14. The computer-implemented method of clause 11, wherein accessing the authorization data includes retrieving, from a local policy cache of the augmented reality user device, a signed policy fragment associated with the physical asset or spatial region.
Clause 15. The computer-implemented method of clause 14, further comprising: verifying a signature of the signed policy fragment before determining whether presentation of the digital content item satisfies the one or more machine-readable rendering constraints.
Clause 16. The computer-implemented method of clause 11, wherein accessing the authorization data includes obtaining a cryptographically signed rendering token associated with the digital content item, and wherein determining whether presentation of the digital content item satisfies the one or more machine-readable rendering constraints includes validating the cryptographically signed rendering token using a public key.
Clause 17. The computer-implemented method of clause 16, wherein validating the cryptographically signed rendering token includes determining whether at least one of an expiration time, a content hash, a policy version identifier, a spatial-region identifier, a presentation-format condition, or a device-context condition encoded in the cryptographically signed rendering token is satisfied.
Clause 18. The computer-implemented method of clause 11, wherein the presentation control operation includes rendering the digital content item, suppressing the digital content item, relocating the digital content item, modifying a visual characteristic of the digital content item, delaying presentation of the digital content item, substituting different digital content for the digital content item, disabling an interactive function associated with the digital content item, disabling audio output associated with the digital content item, or presenting a placeholder in place of the digital content item.
Clause 19. The computer-implemented method of clause 11, further comprising generating, by the augmented reality user device, a local audit record indicating the presentation control operation applied to the digital content item, wherein the local audit record excludes raw gaze data or raw location data and includes a privacy-preserving proof or aggregate presentation indicator.
Clause 20. A tangible, non-transitory computer-readable medium storing instructions that, when executed by one or more processors, cause the one or more processors to perform operations implementing any of one or more of the embodiments recited in clauses 1-10.
Clause 21. A tangible, non-transitory computer-readable medium storing instructions that, when executed by one or more processors, cause the one or more processors to perform operations implementing any of one or more of the embodiments recited in clauses 11-19.
Clause 22. A computer system comprising: one or more processors; and a memory storing instructions that, when executed by the one or more processors, cause the computer system to: implement any of one or more of the embodiments recited in clauses 1-10.
Clause 23. A computer system comprising: one or more processors; and a memory storing instructions that, when executed by the one or more processors, cause the computer system to: implement any of one or more of the embodiments recited in clauses 11-19.

What is claimed is:

1. A computer-implemented method, comprising:
receiving, by one or more processors of a spatial content authorization system, a rendering authorization request for presenting a digital content item in an augmented reality environment, the rendering authorization request identifying the digital content item and a physical asset or spatial region with which the digital content item is proposed to be visually associated;
retrieving, by the one or more processors, a machine-readable presentation policy associated with the physical asset or spatial region, the machine-readable presentation policy specifying spatial presentation constraints and content presentation constraints for augmented reality content associated with the physical asset or spatial region;
extracting, by the one or more processors and from the rendering authorization request, request parameters including at least a content classification parameter, a spatial-context parameter, and a presentation-format parameter;
comparing, by the one or more processors, the request parameters with the machine-readable presentation policy to determine whether the rendering authorization request satisfies the spatial presentation constraints and the content presentation constraints;
generating, by the one or more processors and based on the comparing, a rendering authorization output that specifies whether the digital content item is permitted to be presented in association with the physical asset or spatial region; and
transmitting, by the one or more processors, the rendering authorization output to an augmented reality rendering system configured to control presentation of the digital content item in the augmented reality environment.

2. The computer-implemented method of claim 1, wherein the machine-readable presentation policy includes one or more of a geofence identifier, a façade identifier, a parcel identifier, a viewing-angle constraint, a viewing-distance constraint, a time-window constraint, a permitted presentation-format constraint, an interactivity constraint, an audio-output constraint, or a privacy-condition constraint.

3. The computer-implemented method of claim 1, wherein extracting the request parameters includes determining, from the rendering authorization request, at least one of a location of an augmented reality user device, a pose of the augmented reality user device, a gaze direction, a field-of-view parameter, an ambient condition, a requested display duration, or a requested impression-count parameter.

4. The computer-implemented method of claim 1, further comprising:
when the comparing indicates that a deterministic constraint of the machine-readable presentation policy is not satisfied, generating a modified rendering authorization output that specifies at least one modified presentation parameter under which the digital content item is permitted to be presented.

5. The computer-implemented method of claim 4, wherein the at least one modified presentation parameter includes a modified spatial region, a modified presentation format, a modified presentation duration, a modified viewing-angle condition, a modified interactivity condition, or a modified audio-output condition.

6. The computer-implemented method of claim 1, further comprising:
generating a semantic representation of at least one of the digital content item or metadata associated with the digital content item, comparing the semantic representation with a semantic representation of at least a portion of the machine-readable presentation policy, and determining semantic compatibility between the digital content item and the machine-readable presentation policy based on the comparison.

7. The computer-implemented method of claim 6, wherein determining the semantic compatibility includes computing a similarity score between the semantic representation of the digital content item and the semantic representation of the portion of the machine-readable presentation policy, and determining that the rendering authorization request satisfies a policy condition when the similarity score satisfies a threshold.

8. The computer-implemented method of claim 1, further comprising:
generating a cryptographically signed rendering token that encodes at least a portion of the rendering authorization output and one or more rendering constraints applicable to presentation of the digital content item.

9. The computer-implemented method of claim 8, wherein the cryptographically signed rendering token includes at least one of an identifier of the digital content item, an identifier of the physical asset or spatial region, a version identifier of the machine-readable presentation policy, a permitted rendering region, an expiration time, a presentation-format condition, a content hash, or a signature generated using a private key associated with the spatial content authorization system.

10. The computer-implemented method of claim 1, further comprising:
storing an audit record associated with the rendering authorization output, wherein the audit record includes at least one of a hash of the machine-readable presentation policy, a policy version identifier, a request identifier, a content identifier, a timestamp, a cryptographic signature, or a distributed-ledger transaction reference.

11. A computer-implemented method comprising:
obtaining, by one or more processors of an augmented reality user device, sensor data associated with a physical environment of the augmented reality user device;
determining, by the one or more processors and based on the sensor data, a physical asset or spatial region within a field of view of the augmented reality user device;
accessing, by the one or more processors, authorization data associated with a digital content item proposed for presentation in association with the physical asset or spatial region;
determining, by the one or more processors and based on the authorization data, whether presentation of the digital content item in association with the physical asset or spatial region satisfies one or more machine-readable rendering constraints; and
controlling, by the one or more processors and based on the determining, presentation of the digital content item by causing the augmented reality user device to apply a presentation control operation to the digital content item relative to the physical asset or spatial region.

12. The computer-implemented method of claim 11, wherein the sensor data includes one or more of location data, inertial measurement data, camera data, depth-sensing data, pose data, gaze data, field of view data, ambient-light data, or orientation data.

13. The computer-implemented method of claim 11, wherein determining the physical asset or spatial region includes mapping a pose or location of the augmented reality user device to at least one of a geofence, parcel, façade, surface, landmark, building, or spatial anchor.

14. The computer-implemented method of claim 11, wherein accessing the authorization data includes retrieving, from a local policy cache of the augmented reality user device, a signed policy fragment associated with the physical asset or spatial region.

15. The computer-implemented method of claim 14, further comprising:
verifying a signature of the signed policy fragment before determining whether presentation of the digital content item satisfies the one or more machine-readable rendering constraints.

16. The computer-implemented method of claim 11, wherein accessing the authorization data includes obtaining a cryptographically signed rendering token associated with the digital content item, and wherein determining whether presentation of the digital content item satisfies the one or more machine-readable rendering constraints includes validating the cryptographically signed rendering token using a public key.

17. The computer-implemented method of claim 16, wherein validating the cryptographically signed rendering token includes determining whether at least one of an expiration time, a content hash, a policy version identifier, a spatial-region identifier, a presentation-format condition, or a device-context condition encoded in the cryptographically signed rendering token is satisfied.

18. The computer-implemented method of claim 11, wherein the presentation control operation includes rendering the digital content item, suppressing the digital content item, relocating the digital content item, modifying a visual characteristic of the digital content item, delaying presentation of the digital content item, substituting different digital content for the digital content item, disabling an interactive function associated with the digital content item, disabling audio output associated with the digital content item, or presenting a placeholder in place of the digital content item.

19. The computer-implemented method of claim 11, further comprising generating, by the augmented reality user device, a local audit record indicating the presentation control operation applied to the digital content item, wherein the local audit record excludes raw gaze data or raw location data and includes a privacy-preserving proof or aggregate presentation indicator.

20. A tangible, non-transitory computer-readable medium storing instructions that, when executed by one or more processors, cause the one or more processors to perform operations comprising:
receiving a rendering authorization request for presenting a digital content item in an augmented reality environment, the rendering authorization request identifying the digital content item and a physical asset or spatial region with which the digital content item is proposed to be visually associated;
retrieving a machine-readable presentation policy associated with the physical asset or spatial region, the machine-readable presentation policy specifying spatial presentation constraints and content presentation constraints for augmented reality content associated with the physical asset or spatial region;
extracting, from the rendering authorization request, request parameters including at least a content classification parameter, a spatial-context parameter, and a presentation-format parameter;
comparing the request parameters with the machine-readable presentation policy to determine whether the rendering authorization request satisfies the spatial presentation constraints and the content presentation constraints;
generating, based on the comparing, a rendering authorization output that specifies whether the digital content item is permitted to be presented in association with the physical asset or spatial region; and
transmitting the rendering authorization output to an augmented reality rendering system configured to control presentation of the digital content item in the augmented reality environment.
